(19) United States
(12) Patent Application Publication
(10) Pub. No.: US 2005/0260107 A1
(43) Pub. Date: Nov. 24, 2005

(54) Method, process, chemistry and apparatus for treating a substrate

(76) Inventors: David P. Jackson, Saugus, CA (US); Arthur Trapotsis, Arlington, MA (US); Thomas A. Wells, Santa Clara, CA (US)

Correspondence Address: EDWARDS & ANGELL, LLP, P.O. BOX 55874, BOSTON, MA, 02205, US

(21) Appl. No.: 10/527,427

(22) PCT Filed: Jul. 1, 2004
(86) PCT No.: PCT/US04/21378

§ 371 Date: Mar. 9, 2005

(30) Foreign Application Priority Data
Jul. 1, 2003 (US) 60483637

(51) Int. Cl. B32B 27/12

(52) U.S. Cl. 422/136

(57) ABSTRACT

The invention provides new methods for synthesis of percarbonic acid and methods of using percarbonic acid compositions for the treatment of substrates. The invention is particularly useful for cleaning, disinfecting and/or sterilizing a substrate using percarbonic acid or a percarbonic acid-carbon dioxide mixture. The invention further provides an apparatus suitable for use in the substrate treatment methods provided herein. The invention also provides methods and apparatus for the real time monitoring of the treatment processes provided herein.

### BACKGROUND

1. Field of the Invention

The invention provides methods for synthesizing compositions comprising percarbonic acid, or more preferably percarbonic acid and carbon dioxide. The invention further provides cleaning, disinfecting, and sterilizing methods using percarbonic acid compositions. The invention further provides cleaning, disinfecting, and sterilizing apparatus which are suitable for use in the cleaning, disinfecting and sterilizing methods of the invention and methods of monitoring completion of the cleaning, disinfecting, or sterilizing methods in real time.

2. Background

Timely and effective cleaning and sterilization of medical instruments and devices is of paramount importance to hospitals and to manufacturers of medical products. Several methods of sterilization exist, all with their own advantages and drawbacks. Steam can be used to sterilize some instruments, but not all devices and materials are able to withstand the extremely high temperatures and pressures associated with steam. For example, a variety of polymeric substrates are susceptible to deformation or melting at the operating temperatures and pressures associated with steam disinfection.

The use of radiation to sterilize substrates has been hampered by incompatibility of a variety of materials and the inaccessibility of radiation sterilization facilities at individual hospitals. More particularly, radiation sterilization often induced undesirable decomposition or degradation of substrate during the sterilization process.

Several chemical sterilization protocols have been developed. Ethylene oxide, which has been an industry standard for gaseous sterilization of substrates, has been under increasing scrutiny in both hospital and manufacturing settings. Ethylene oxide (EtO) itself is a chemical hazardous to human health, and traditional ethylene oxide sterilization methods are harmful to the environment. Moreover EtO sterilization process time can be as long as 15 hours to complete. Other chemical sterilization technologies using peracetic acid and glutaraldehyde liquids have proven costly and difficult to use in a wide variety of settings.

Advanced Oxidation Processes (AOP) utilizing hydrogen peroxide or ozone and in combination with UV radiation or a type of plasma (low pressure or atmospheric), as well as vapor phase hydrogen peroxide are gaining widespread use in sterilizing medical devices. However, challenges remain using these techniques with regards to sterilizing complex medical devices such as endoscopes in a timely and effective manner.

Traditional hospital medical device re-processing procedures typically include separate gross cleaning, device functional testing, precision cleaning, disinfection, and terminal sterilization protocols and equipment. The hospital and support staff has three in-house cleaning and decontamination options—1) purchase a washer-disinfection system, 2) purchase a just-in-time sterilization system and 3) purchase a terminal sterilization system (i.e., EtO system). Conventional washer-disinfectors can provide some level of precision cleaning and disinfection, but do not provide a sterile device by FDA medical definition. Conventional medical sterilizers provide for a sterile device, which is dependent upon how well the pre-cleaning was performed, but do not provide a clean device by industry precision cleaning definition.

Complex devices are frequently constructed from a plurality of materials each of which possesses different physical and chemical properties. Cleaning or sterilizing agents and processes must be “active” enough to remove and/or deactivate biological contamination, but “inactive” enough to prevent the destruction or degradation of each material incorporated into the complex medical device.

The need for an advanced clean-sterilization technology is based upon an understanding of the interdependency of cleaning and sterilization, as well as materials compatibility issues.

Cleaning is the process of substantially removing unwanted surface residues, including solid, liquid, gaseous, organic and inorganic, particulate, radiological and biological contaminants. Preferred cleaning methods typically use a minimal amount of chemical and physical energy in an optimum combination to remove unwanted surface residues.

Disinfecting is the destruction of all vegetative microorganisms, mycobacteria, small or non-lipid viruses, medium or lipid viruses, fungal spores, and some but not all bacterial spores. Preferred disinfecting methods typically use a minimal amount of chemical and physical energy in an optimum combination to remove or deactivate disease or infection causing microbes.

In general, an application of good mechanical cleaning action (i.e., ultrasonic agitation) and chemical cleaning action (i.e., enzymatic cleaners) can remove most soils from simple surface geometries without damaging medical device substrate materials themselves. Most current cleaning processes are unable to satisfactorily meet the challenge of cleaning both the internal and external surfaces, lumens, and other structures of current complex medical devices. More particularly, current cleaning processes lack one or more of adequate diffusion into, cleaning action within, effusion from, and proper rinsing and drying of complex medical devices in order to provide satisfactory cleaning.

In contrast to disinfection, sterilization is defined as a process that will destroy all forms of microbial life on an article or substrate. In practice, in order for a product to be labeled “sterile”, the product is treated with a process which has been validated to produce a SAL of 10-6. The SAL (sterilization assurance level) for a process is a measure of the percent reduction or number of logarithmic reductions (D values) brought about by the sterilization process. For example, a sterilized article having a SAL of 10-6 has a probability of contamination of less than about 1 in one million. Thus, sterilization of a medical device is the process of inactivating trace microbial contaminations not chemically or physically removed by rigorous pre-cleaning and disinfection processes. Sterilization of medical devices is often complicated by incompatibility between the sterilizing protocol and the medical device.

It is well known that physical removal of sub-micron contamination, such as microbes or microbial spores, requires extremely high shear stress to remove them from substrate surfaces. This is a challenging feat for complex medical devices having hidden cavities and long lumens. Moreover, many spores exhibit resistance to high temperatures and pressures as well as oxidative chemistries that will destroy or damage many medical device substrates if employed in too high of a concentration or if the substrates are exposed to these conditions for too long a period of time.

Cleaning and sterilizing agents must be able to wick into or diffuse through long and narrow capillaries, hinged structures, and other complex substrate features and subsequently be removed from said structural features. Complex devices such as endoscopes have tortuous physical geometries, valves, multiple layers, hidden chambers and cavities. Diffusion into and removal from substrates having complex structures is a

During and following cleaning and sterilization procedures, these same agents must be able to be removed from these same geometries. This is most often harder to accomplish than diffusion into critical surfaces.

In U.S. Pat. No. 5,213,619, Jackson teaches using a dense fluid with hydrogen peroxide and acoustic radiation to clean and sterilize a substrate. This process produces intense acoustic radiation under the dense fluid pressure and temperature conditions employed which can result in severe substrate damage to many complex devices and many polymers.

In another invention, U.S. Pat. No. 6,558,622, Malchesky teaches a multi-step process of cleaning with a dense fluid such liquid carbon dioxide, draining the container, and then disinfecting with a second step using a disinfectant such as ozone, hydrogen peroxide, and then rinsing residual disinfectants and residuals with said dense fluid using a third sequence. The process as described in '622 requires several steps and does not provide an efficient activation or diffusion means for the cleaning and sterilization fluids employed, and the substrates being treated. Moreover, it is well known that aqueous compositions comprising dense fluids form binary mixtures due to divergent cohesive energies. These fluids cannot be used effectively without a mechanical agitation means, which is not taught by '622. Moreover, '622 does not provide an effective means for drying complex devices following aqueous treatments. Traditional vacuum drying under static conditions tends to freeze liquid contaminants and processing fluids within small pores. The use of a dense fluid as a rinsing agent is rather ineffective due to the poor solubility of aqueous compositions and other disinfectants in simple dense fluid solvents such as carbon dioxide.

In U.S. Pat. No. 5,236,602, Jackson teaches the use of dense fluids in combination with ozone or peroxide compositions with ultraviolet radiation activation as a means for removing undesirable materials from a substrate. This process directs a UV radiation into a container immersed in a dense fluid composition, preferably dense phase carbon dioxide and additive. The drawbacks of this process are that complex medical devices such as endoscopes cannot withstand the pressures employed and there is no means for diffusing active cleaning and sterilizing species into and out of diffusion-restricted interfaces. Moreover, for a sterilization process to be effective, soils must be first removed from the substrate in a cleaning step prior to a sterilization step.

U.S. Pat. No. 4,943,414, Jacobs discloses a process in which a vessel containing a small amount of a vaporizable liquid sterilant solution is attached to a lumen, and the sterilant vaporizes and flows directly into the lumen of the article as the pressure is reduced during the sterilization cycle. This system has the advantage that the water and hydrogen peroxide vapor are pulled through the lumen by the pressure differential that exists, increasing the sterilization rate for lumens, but it has the disadvantage that the vessel needs to be attached to each lumen to be sterilized. In addition, water is vaporized faster and precedes the hydrogen peroxide vapor into the lumen, discussed in more detail below.

U.S. Pat. No. 5,368,171 teaches the use of a centrifuge in combination with dense fluids and microwave radiation to enhance extraction of contaminants from deeply recessed surfaces such as those found with polymeric implantable tubing. The main disadvantage of this process is that residual biological contaminants such as viable bacterial spores will remain on internal surfaces following the cleaning process. A final sterilization step is necessary to effectively destroy residual biological contaminants.

Moreover, recent research using dense fluids, UV light, plasma, extreme high pressure, and pulsed electric field to inactivate bacterial spores exemplify the extreme resistance of viable biological contamination (i.e., bacterial spores) to seemly harsh energy, pressure and temperature conditions. For example, inactivation of bacteria and non-vegetative spores using supercritical carbon dioxide under extreme pressure (205 atm), high temperature (60 C) requires contact times of nearly 4 hours. Moreover, reports of inactivating bacterial spores using a variety of “high energy” methods including UV light, pulsed electric discharge, plasma, and high pressure processing have resulted in inconsistent results. Thus, the significant challenge of cleaning, disinfecting, and sterilizing substrates remains.

Sterilization using hydrogen peroxide vapor has been shown to have some advantages over other chemical sterilization processes. However, using aqueous solutions of hydrogen peroxide to generate hydrogen peroxide vapor for sterilization is problematic. At higher pressures, such as atmospheric pressure, excess water in the sterilization system can cause condensation when aqueous hydrogen peroxide is used at or above ambient pressure. Aqueous hydrogen peroxide and gaseous hydrogen peroxide prepared from same are not suitable for substrates having diffusion restricted domains (such as long narrow lumens and the like). Thus, for example, problems associated with aqueous hydrogen peroxide include: (a) water vaporizes faster than hydrogen peroxide, in part due to its higher vapor pressure, and (b) water diffuses at a faster rate than hydrogen peroxide in part because it has a smaller molecular size and a smaller molecular weight.

Thus, although not wishing to be bound by theory, the use of vapors generated from aqueous hydrogen peroxide results in water reaching substrate surfaces first and in higher concentration than hydrogen peroxide. Thus, the water vapor acts as a barrier to hydrogen peroxide penetration into diffusion-restricted areas, such as small crevices and long narrow lumens.

Several issued U.S. patents recite methods of sterilizing substrates using hydrogen peroxide under a variety of conditions.

In U.S. Pat. Nos. 4,169,123, 4,169,124, and 4,643,876, the combination of hydrogen peroxide with non-thermal plasmas provides additional advantage In these disclosures the hydrogen peroxide vapor is generated from an aqueous solution of hydrogen peroxide, which ensures that there is moisture present in the system.

U.S. Pat. Nos. 4,642,165 and 4,744,951, issued to Bier and Cummings et al., respectively, attempt to address this problem. Bier attempts to solve the problem by metering small increments of a hydrogen peroxide solution onto a heated surface to ensure that each increment is vaporized before the next increment is added. This helps to eliminate the difference in the vapor pressure and volatility between hydrogen peroxide and water, but it does not address the fact that water diffuses faster than hydrogen peroxide in the vapor state. Cummings et al. describe a process for concentrating hydrogen peroxide from a relatively dilute solution of hydrogen peroxide and water and supplying the concentrated hydrogen peroxide in vapor form to a sterilization chamber. The process involves vaporizing a major portion of the water from the solution and removing the water vapor produced before injecting the concentrated hydrogen peroxide vapor into the sterilization chamber. The preferred range for the concentrated hydrogen peroxide solution is 50% to 80% by weight. This process has the disadvantage of working with solutions that are in the hazardous range; i.e., greater than 65% hydrogen peroxide, and also does not remove all of the water from the vapor state. Since water is still present in the solution, it will vaporize first, diffuse faster, and reach the items to be sterilized first. This effect will be especially pronounced in long narrow lumens.

Another way of introducing anhydrous peroxide into a process involves using peroxide complexes. Hydrogen peroxide is capable of forming Lewis acid-base complexes with both organic and inorganic compounds. The binding in these complexes is attributed to hydrogen bonding between electron rich functional groups in the complexing compound and the peroxide hydrogen. The complexes have been used in commercial and industrial applications such as bleaching agents, disinfectants, sterilizing agents, oxidizing reagents in organic synthesis, and catalysts for free radical-induced polymerization reactions.

In U.S. Pat. No. 5,008,106, Merianos teaches that a substantially anhydrous complex of PVP and H₂O₂ is useful for reducing the microbial content of surfaces. The complex, in the form of a fine white powder, is used to form antimicrobial solutions, gels, ointments, etc. It can also be applied to gauze, cotton swabs, sponges and the like. The H₂O₂ is released upon contact with water present on the surfaces containing the microbes. The use of anhydrous solids such as these in the present invention would be ineffective due to a lack of solubility in various fluids including dense phase carbon dioxide.

In U.S. Pat. No. 2,986,448, Gates prepared a sodium carbonate hydrogen peroxide complex by treating a saturated aqueous solution of sodium carbonate with a solution of 50 to 90% H₂O₂ in a closed cyclic system at 0 C to 5 C for 4 to 12 hours. More recently, Hall et al. (U.S. Pat. No. 3,870,783) prepared sodium carbonate hydrogen peroxide complex by reacting aqueous solutions of hydrogen peroxide and sodium carbonate in a batch or continuous crystallizer. The crystals are separated by filtration or centrifugation and the liquors used to produce more sodium carbonate solution. These methods work well for peroxide complexes that form stable, crystalline free-flowing products from aqueous solution, but cannot be used in anhydrous treatments.

More recently, new “activated hydrogen peroxide solutions,” such as solutions of peracetic acid, have been developed using acidic and organic complex formulations.

U.S. Pat. No. 5,288,460, issued to Caputo, et al., teaches using a pulsed RF plasma in a vacuum chamber, and containing a substrate to be treated, to generate a temperature cycle with ceiling temperatures as high as 132 C. The plasma is used to create radicals and high RF power plus oxygen and hydrogen are used to drive the plasma-temperature cycle.

U.S. Pat. No. 5,413,758, issued to Caputo, et al., teaches using pulsed flows of antimicrobial agent (i.e., Peracetic Acid) into a lyophilizer acting as a vacuum chamber, and receiving plasma by-products downstream through a connection.

U.S. Pat. No. 5,656,238, issued to Spencer et al., teaches an improved drying method using a radio-frequency (RF) plasma in a vacuum chamber in combination with pressure swing to dry a substrate. This is followed by a second plasma-sterilant treatment cycle.

U.S. Pat. No. 5,876,666, issued to Lin et al., teaches using a non-aqueous organic hydrogen peroxide under low humidity and a radio-frequency (RF) plasma to generate dry peroxide sterilization treatment cycle.

U.S. Pat. No. 5,980,825, issued to Addy et al., teaches the method of contacting a substrate with liquid hydrogen peroxide solution (soaking) and then placing the soaked substrate in a plasma chamber, heating said substrate (which may be contained within a permeable structure) and exposing said substrate to a drying vacuum cycle and then an RF plasma.

U.S. Pat. No. 6,343,425, issued to Sias et al., teaches the use of a disinfection and cleaning glove-box, wherein a substrate (i.e., Operator Gloves) is inserted and exposed to a shower of hydrogen peroxide and atmospheric plasma-induced radicals.

U.S. Pat. No. 6,365,102, issued to Wu et al., teaches a method of the combination of pressure cycling, soaking, and RF plasma power cycling with hydrogen peroxide to condition and treat a substrate with reduced RF induced damage.

U.S. Pat. No. 6,365,103, issued to Fournier, teaches the use of direct communication of a source of humidified ozone into the lumens of an endoscope for a period of time.

U.S. Pat. No. 6,342,187, issued to Jacob et al., teaches the use of a glowless RF discharge to sterilize substrates to minimize plasma damage to substrates.

U.S. Pat. No. 5,761,069, issued to Weber et al., teaches an integrated cleaning and sterilization system using ultrasonic cavitations.

U.S. Pat. No. 6,423,266, issued to Choperena et al., teaches a flow-through container for cleaning lumen-containing devices such as endoscopes.

In general, the aforementioned approaches have the following common disadvantages with respect to overcoming the cleaning and sterilization challenges discussed herein.
1. Extremely wet substrates cannot be processed effectively and require long vacuum or plasma drying cycles. Conventional substrate drying methods such as plasma drying unnecessarily exposes outside substrate surfaces to long periods of environmental stress and may cause damage to sensitive surfaces. Moreover, non-aqueous dense fluid (i.e., liquid, plasma, and supercritical carbon dioxide) processes cannot be effectively integrated with aqueous (i.e., aqueous enzymatic or peroxide cleaners) processes without an improved method for removing residual aqueous media prior to introducing non-aqueous media.
2. Due to the heterogeneous nature of conventional treatment plasmas and plasma processes, the use of only vacuum convective or diffusion flow phenomenon in a cleaning or sterilization treatment creates the possibility of un-clean or non-sterile substrates if treatment times are too short or when substrate geometries are very complex (i.e., long lumens within endoscopes).
3. The use of static or un-mixed non-thermal plasmas increases the overall process time needed to achieve cleanliness or sterility due to heterogeneous treatment conditions in and phase behavior of non-newtonian fluids such as plasmas. This requires excessive or uneven exposure of various substrate surfaces to achieve results for the most diffusion-restricted substrates.
4. The use of high process temperatures increases the risk of damage to sensitive substrates and is especially problematic for complex substrates having metal and polymer construction.
5. Conventional plasma gases such as air, oxygen, and hydrogen do not benefit reaction environmental conditions with elements such as lower surface tension, low pH, and complex formation, among others.
6. The utilization of remote plasma sources to communicate active species (radicals, ions etc.) to the treatment process significantly reduces the concentration of active species that actually contact substrate surfaces and contaminants.
7. The use of treatment fluids such as organic acid complexes of hydrogen peroxide may corrode or react with various substrate materials under plasma energy conditions to form undesirable reaction by-products.
8. Treatment plasmas (atmospheric and sub-atmospheric conditions) tend to work effectively in line of sight and do not penetrate or form in diffusion-restricted spaces such as long lumens or very small capillaries.
9. The use of direct physical connections and flow of treatment fluids through complex substrate geometries such as lumens is cumbersome and does not allow for the treatment of large quantities or mixed batches of complex materials.

Improperly cleaned and sterilized implantable devices often cause or contribute to device rejection and/or infections in patients. More particularly, increased occurrences of nosocomial infections caused by improperly reprocessed medical tools is often attributed to conventional cleaning and sterilization procedures which fail to properly clean or sterilize the tools. The need for reproducible cleaning and sterilization methods is expected to increase due to the development of more complex medical devices and increased development of recyclable medical devices.

Although there are several cleaning, disinfecting, and sterilizing agents currently available and various methods of using same to clean, disinfect, and/or sterilize substrates, it remains a desirable target to develop new cleaning, disinfecting, and sterilizing agents and methods which are capable of cleaning, disinfecting, or sterilizing a variety of complex substrates which are reproducible and without damage to the substrate. It would be particularly desirable to develop a cleaning, disinfecting, or sterilizing agent based on carbonic acid, optionally in conjunction with plasma and/or UV irradiation for cleaning, disinfecting, or sterilizing substrates.

### SUMMARY OF THE INVENTION

Remarkably, we have discovered new methods for the preparation of compositions comprising percarbonic acid or a mixture of percarbonic acid and carbon dioxide. The invention is particularly useful for synthesis of percarbonic acid compositions which are substantially free of water, e.g., anhydrous or dry percarbonic acid compositions. The present invention also relates to methods of treating substrates comprising contacting the substrate with a percarbonic acid composition prepared using the methods of the invention, optionally in conjunction with a plasma, physical agitation, and/or irradiation. In certain preferred aspects, the treatment methods of the invention include methods of cleaning, disinfecting and/or sterilizing substrates. In some preferred embodiments, the invention provides methods of cleaning, disinfecting and/or sterilizing a substrate in which a percarbonic acid composition is contacted with a substrate in conjunction with the application of a physical force.

Thus, in one aspect, the invention provides methods of synthesis of preparing percarbonic acid or a composition comprising same. The method of synthesis comprises the step of contacting hydrogen peroxide and carbon dioxide under conditions conducive to formation of percarbonic acid. The invention further provides, in certain aspects, uses of the percarbonic acid prepared by the methods of the invention as a substrate treatment agent or as a cleaning, disinfectant, or sterilization agent.

In certain other aspects, the invention provides methods of treating a substrate, the method comprising the step of contacting the substrate with a fluid comprising percarbonic acid under conditions conducive to substrate treatment. Certain preferred treatment methods comprise those in which a substrate is modified, cleaned, disinfected and/or sterilized by exposure to percarbonic acid or exposure to percarbonic acid in the presence of one or more additives.

Certain preferred methods of cleaning, disinfecting and/or sterilizing methods provided by the invention include those methods comprising the step of contacting a substrate with a fluid comprising percarbonic acid under conditions conducive to removing contaminants from the substrate.

Yet other preferred methods of cleaning, disinfecting or sterilizing a substrate provided by the invention include those methods comprising the steps of
applying a translational force to the substrate; and
contacting a substrate with a fluid comprising percarbonic acid under conditions conducive to removing contaminants from the substrate.

In yet another aspect, the invention provides an apparatus for treating a substrate with percarbonic acid comprising a cleaning chamber, a UV irradiation source, an electrical field generator, a device capable of applying a translational force to the substrate, and a percarbonic acid generator or percarbonic acid source. Certain preferred apparatus include those which are suitable for cleaning, disinfecting and/or sterilizing a substrate with a percarbonic acid composition.

In certain other aspects, the invention provides methods and apparatus for real time monitoring of the substrate treatment methods provided by the invention. The monitoring methods provided herein typically comprise the steps of: (a) providing a test substrate having at least one chemical or biological contaminant deposited thereon; (b) measuring the UV-Vis spectrum of the test substrate prior to cleaning or sterilizing; (c) contacting the test substrate with the fluid comprising percarbonic acid under conditions conducive to cleaning or sterilizing the substrate; (d) measuring the UV-Vis spectrum of the test substrate periodically during and after contacting the test substrate with the fluid; and (e) comparing the periodic UV-Vis spectra against the pre-cleaning or pre-sterilizing UV-Vis spectrum to monitor the cleaning or sterilization process.

Other aspects of the invention are discussed infra.

### BRIEF DESCRIPTION OF THE DRAWINGS

FIG. 1 is a table of various chemical and physical properties of hydrogen peroxide;

FIG. 2 is a table of various chemical and physical properties of carbon dioxide;

FIG. 3 is a graph showing effect of various gases upon the surface tension of water (i.e., dihydrogen oxide) versus pressure;

FIG. 4 is a graph showing the predominance of various carbonate species versus pH;

FIG. 5 is graph showing the concentration of carbon dioxide species in water versus pressure and temperature;

FIG. 6 is a graph showing the acidification effect of oxy acids upon hydrogen peroxide reaction pH;

FIG. 7 is an exemplary apparatus for formulating and delivering percarbonic acid;

FIG. 8 is a graph showing the possible sporicidal mechanisms of percarbonic acid;

FIG. 9 is a schematic diagram showing the various types of plasma and photoplasma used herein;

FIG. 10 is a graph showing the typical UV-VIS light characteristics of the preferred xenon UV light source in relation to its selectivity for hydrogen peroxide and water;

FIG. 11 is a graph showing the light absorption shift of complexed hydrogen peroxide;

FIG. 12 is a graph showing the plasma emission spectrum for carbon dioxide;

FIG. 13 is a schematic diagram showing the phenomenon associated with centrifugal and Coriolis forces used herein;

FIG. 14 is a schematic diagram showing the mechanism for enhanced dehydration of hydrogen peroxide or substrate surfaces using centrifugal and Coriolis forces;

FIG. 15 is a graph representing an exemplary centrifugal pressure swing adsorption-desorption (CPSA) cycle;

FIG. 16 is a drawing of an exemplary vertical UV-Plasma centrifuge treatment apparatus;

FIG. 17 is a drawing of an exemplary horizontal UV-Plasma centrifuge treatment apparatus;

FIG. 18 is a drawing of an exemplary UV-Plasma centrifuge treatment system;

FIG. 19a and FIG. 19b are drawings of an exemplary centrifuge compartmentalization scheme;

FIG. 20 is a drawing of an exemplary dense fluid management system for recycling dense fluids;

FIG. 21 is a schematic diagram showing the overall architecture of a UV-Plasma centrifuge treatment system;

FIG. 22 is a diagram showing the exemplary treatment process and method embodiments;

FIG. 23 is a diagram showing the exemplary treatment process and method architecture;

FIG. 24 is a scientific diagram showing an exemplary clean-sterilization treatment cycle;

FIG. 25 is a flowchart showing an exemplary clean-sterilization treatment method using a aqueous percarbonic acid pre-wash step;

FIG. 26 is a flowchart showing an exemplary clean-sterilization treatment method using a dense phase carbon dioxide pre-wash step;

FIG. 27 is a flowchart showing an exemplary clean-sterilization treatment method using a dense phase carbon dioxide extraction pretreatment step and ending with surface functionalization and coating finishing steps, respectively;

FIG. 28 is a graph showing a typical cleaning profile using dense phase carbon dioxide to pre-treat silicone polymers used in medical devices;

FIG. 29a and FIG. 29b are schematic diagrams showing exemplary UV-VIS spectrophotometric system and indicator, respectively, for monitoring and controlling CPSA/UV-Plasma cleaning, sterilization, functionalization, and coating processes and methods herein; and

FIG. 30 is a schematic diagram showing an exemplary test apparatus for determining the treatment efficacy of complex devices such as medical devices having lumens.

### DETAILED DESCRIPTION OF THE INVENTION

Remarkably, we have discovered new methods for the preparation of percarbonic acid compositions, including compositions percarbonic acid and carbon dioxide, which can be useful as cleaning, disinfecting, and/or sterilizing agents for treatment of various substrates.

In one preferred aspect, the invention provides a method of preparing percarbonic acid or a composition comprising same, the method comprising the step of contacting hydrogen peroxide and carbon dioxide under conditions conducive to formation of percarbonic acid. The invention further provides uses of the percarbonic acid compositions prepared by the methods of the invention as a cleaning, disinfecting or sterilizing agent.

In certain aspects, the invention provides methods of preparing percarbonic acid or a composition comprising same, the method comprising the step of contacting hydrogen peroxide and carbon dioxide under conditions conducive to formation of percarbonic acid. In some preferred percarbonic acid synthesis methods of the invention, the hydrogen peroxide is an aqueous hydrogen peroxide solution, and in other particularly preferred methods, the hydrogen peroxide is provided as an aqueous hydrogen peroxide solution having between about 1 and about 65% hydrogen peroxide by weight, or between about 30% and about 40% hydrogen peroxide by weight.

Thus, in some preferred methods of synthesis of the invention, gaseous, liquid, plasma, and supercritical fluids, and most preferably carbon dioxide (CO₂), are combined with hydrogen peroxide to form a carbon dioxide-hydrogen peroxide complexes called percarbonic acid (H₂CO₄), or PCA herein. The present invention teaches a technique for preparing a concentrated dry and inorganic hydrogen peroxide for use in the cleaning, disinfecting, and/or sterilizing methods of present invention. The synthesis involves gas-liquid, liquid-liquid, and supercritical fluid-liquid extraction of an aqueous solution of hydrogen peroxide (i.e., 65% by vol.) using gas, liquid, or supercritical carbon dioxide to produce an inorganic and low water content supernatant having a higher concentration of hydrogen peroxide-carbon dioxide complex (PCA). The concentrated peroxide may be injected directly into the processing chamber and used as a source of both CO₂ and H₂O₂. Pressure and temperature, in combination with other embodiments of the present invention such as UV-Plasma, are used to selectively release the anhydrous hydrogen peroxide from the complex. Moreover, a semi-aqueous PCA solution is taught for use as a pre-conditioning agent.

In certain preferred methods of percarbonic acid synthesis, the mixture of hydrogen peroxide and carbon dioxide are contacted in the presence of a plasma. In yet other preferred methods of percarbonic acid synthesis, the mixture of hydrogen peroxide and carbon dioxide are contacted in the presence of UV radiation. In certain particularly preferred methods of percarbonic acid synthesis, the mixture of hydrogen peroxide and carbon dioxide are contacted in the presence of a plasma and UV radiation.

Typically preferred percarbonic acid synthesis methods include those in which the hydrogen peroxide and carbon dioxide are contacted at a temperature of between about 5 and 200° C. and a pressure of between 4 and 10 MPa. In certain preferred methods of carbonic acid synthesis, the aqueous solution of hydrogen peroxide is contacted with liquid or supercritical carbon dioxide in a continuous flow extraction apparatus.

In certain other preferred methods of percarbonic acid synthesis provided by the invention, the aqueous solution of hydrogen peroxide is contacted with liquid or supercritical carbon dioxide under conditions conducive to formation of percarbonic acid. More preferably, the aqueous hydrogen peroxide is contacted with supercritical carbon dioxide. In certain preferred percarbonic acid synthetic processes, the aqueous hydrogen peroxide is contacted with supercritical carbon dioxide at a temperature of between about 32 and 100° C. and a pressure of between 7.6 and 35 MPa. In yet other preferred methods of percarbonic acid, the aqueous hydrogen peroxide is contacted with liquid carbon dioxide, more preferably the aqueous hydrogen peroxide and carbon dioxide are contacted at a temperature of between about 5 and 30° C. and a pressure of between 4.5 and 10 MPa.

Although the percarbonic acid prepared by the methods of the invention is suitable for use in any application in which percarbonic acid is used. Certain preferred uses of percarbonic acid prepared herein include, but are not limited to, use as a cleaning, disinfecting, or sterilizing agent for removing organic, inorganic, particulate, or biological contaminants from a substrate. The percarbonic acid prepared by the methods of the invention may optionally be used in combination with carbon dioxide as a cleaning, disinfecting, or sterilizing agent for removing organic, inorganic, particulate, or biological contaminants from a substrate.

Percarbonic acid/carbon dioxide mixtures prepared by the methods of the invention provide a variety of advantages over the teachings of the known cleaning, disinfecting, or sterilization agents, in part, because carbon dioxide offers superior performance as a: heating gas (better thermal capacity as compared to drying air), plasma gas (a source of UV radiation and oxidative radicals such as atomic oxygen for cleaning, sterilization, functionalization and coating processes), acidification agent (formation of carbonic acid and percarbonic acid (superacid formation) for enhanced oxidation reactions and biocidal activity), penetrant and carrier fluid (Excellent permeability as compared to other gases, which is similar to ethylene oxide gas (EtO). Ability to complex hydrogen peroxide allows for improved delivery into complex geometries. Acidifies bacterial spore water content and covalently bonds with Calcium, from Calcium-Dipicolinic acid (Ca-DPA) complex, a principal constituent in spores), complexing agent (complex formation with unsaturated hydrocarbons, water, and hydrogen peroxide improves solubility and UV absorption), drying gas (lowers surface tension of water through Lewis acid-base structuring), Cleaning Fluid (can be densified to liquid, plasma or supercritical fluid states to be used as a cleaning and extraction media), extraction fluid (use in gas-liquid, gas-vapor, liquid-liquid, plasma-vapor, and supercritical fluid-liquid selective extraction or complexation of hydrogen peroxide from dihydrogen oxide solutions), and reaction environment (carbon dioxide uniquely provides numerous treatment process enhancements as described above and enables various peroxide reactions to occur more efficiently (i.e., photo-Fenton like reactions use UV-VIS light quanta more efficiently).

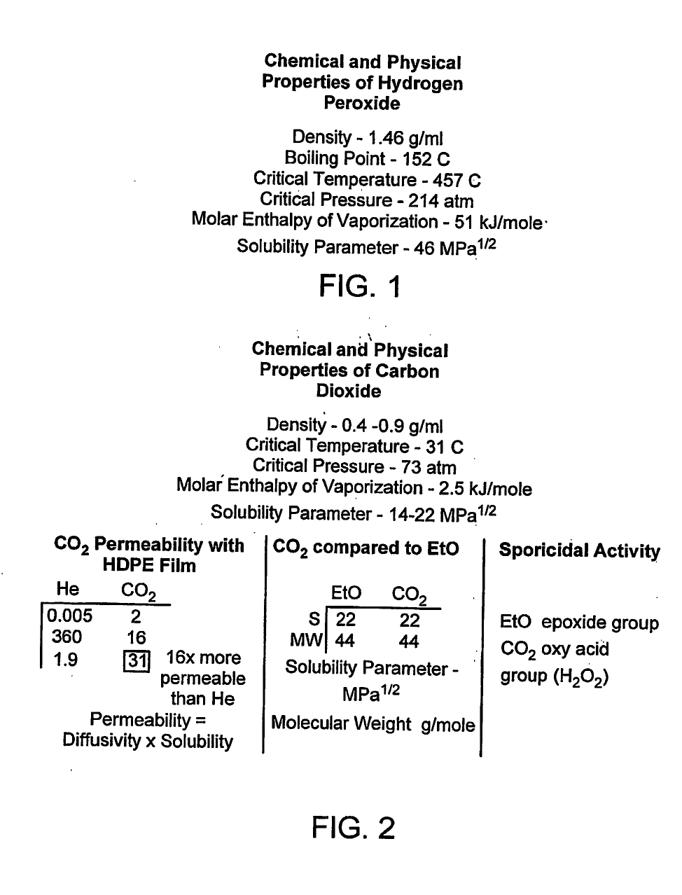

Now referring to FIG. 1, certain relevant physical and chemical properties of hydrogen peroxide are discussed. Most notable from this figure is that hydrogen peroxide exhibits a higher boiling point and density as compared to compounds such as water and carbon dioxide. Although its critical properties and cohesion energy are similar to water, hydrogen peroxide exhibits a larger solubility than water in a range of organic solvents including ether, amyl alcohol, and quinoline (Hydrogen Peroxide, W. Schumb et al., Reinhold Publishing Corporation, New York, N.Y., 1955, pp. 292-293). As already discussed herein, hydrogen peroxide has been used to formulate various activated cleaning and sterilization solutions using acetic acid and potassium carbonate, forming aqueous peracetic acid and percarbonic acid complexes, respectively.

Although cohesion energy differences may be significantly divergent, hydrogen peroxide exhibits solubility with many organic solutions to form non-ideal solutions through the formation of Lewis acid-base complexes. For example, alcohols (δ-22 MPa^{1/2}-30 MPa^{1/2}), ethers (δ-15 MPa^{1/2}-22 MPa^{1/2}), acetic acid (δ-21 MPa^{1/2}), and carbon dioxide (δ-14 MPa^{1/2}-22 MPa^{1/2}) will form Lewis acid-base complexes with hydrogen peroxide (δ-46 MPa^{1/2}).

In the certain aspects of the invention, a hydrogen peroxide-carbon dioxide complex liquid or vapor called percarbonic acid (PCA) is produced directly from an aqueous hydrogen peroxide solution. PCA is produced using a liquid-liquid or supercritical fluid-liquid extraction process and apparatus using carbon dioxide and a concentrated aqueous hydrogen peroxide solution. For example, supercritical carbon dioxide is compressed over a solution of 65% (v:v) hydrogen peroxide and water to form a PCA rich phase above the aqueous phase, which may be further dried or used directly in treatment processes described herein. Similarly liquid carbon may be used to produce a PCA enriched treatment agent for treatment processes described herein.

Moreover, and most preferably used herein, an essentially non-aqueous PCA complex is also generated herein from an aqueous solution, which is processed to remove water using carbon dioxide and water extraction of an aqueous PCA solution, which has been injected, into a process chamber. Thus, where aqueous PCA is used, the aqueous complex is converted to a substantially non-aqueous and inorganic hydrogen peroxide complex while carrying out the process of the present invention. Additional-water may be present in the form of the carbonic acid complex and from the decomposition of hydrogen peroxide to form water and oxygen as byproducts and some hydrogen binding of this water to the PCA complex can occur.

One consideration for selection of the hydrogen peroxide source composition is stability of the hydrogen peroxide composition and the evaporation rate of the hydrogen peroxide as a function of temperature and pressure. Depending on the parameters of the cleaning and sterilization process, for example pressure and temperature, a higher or lower peroxide evaporation rate may be preferred, and heating the peroxide source may or may not be required. In general, heating the PCA complex increases the vapor pressure of hydrogen peroxide and carbon dioxide gas, accelerating the release of peroxide from the complex.

Achieving suitable evaporation rates of anhydrous peroxide vapor from the source may be facilitated by elevated temperatures and/or reduced pressure. Thus, a heater for the peroxide source and/or a vacuum pump to evacuate the sterilization chamber is preferably a part of treatment apparatuses taught herein. A substrate may be covered with a layer of gas permeable material, such as a non-woven polyethylene fabric or non-woven polypropylene, which permits the PCA/peroxide vapor to pass. Perforated aluminum or other suitable perforated material could also be used as a cover.

Sterilization using PCA can be achieved with or without the use of UV-Plasma and centrifugation processes taught herein. However, both the UV-Plasma and centrifugal embodiments herein will significantly enhance the sporicidal activity of the PCA/peroxide vapor, and/or to remove any residual hydrogen peroxide and water remaining on the cleaned and sterilized articles.

The methods of percarbonic acid synthesis and the apparatus suitable for use in said methods of synthesis can be used as a percarbonic acid generator for the treatment methods of the invention or the plasma treatment methods recited in U.S. Pat. Nos. 4,643,876, 5,225,166, or 5,087,418.

The methods of percarbonic acid synthesis provided herein offer a variety of benefits over previously recited methods of synthesis, including but not limited to: (1) avoiding necessity of storing or using concentrated and potentially hazardous hydrogen peroxide solutions; (2) avoiding storage and use of potentially dangerous organic peroxides; (3) competition with water for diffusion into long narrow lumens and other complex structures; and (4) obviating need for specialized fixtures or adapters for delivering liquids or gases to internal volumes (e.g., lumens and the like) of the substrate.

In certain preferred methods of percarbonic acid synthesis, the percarbonic acid is prepared as a mixture with carbon dioxide. In certain preferred treatment methods of the invention it is desirable to deliver a mixture of percarbonic acid and carbon dioxide as a cleaning, disinfecting and/or sterilizing agent.

FIG. 2 provides certain chemical and physical properties for carbon dioxide. Thus, carbon dioxide exhibits a range of liquid-like densities and a critical temperature near room temperature. Most significantly, carbon dioxide exhibits a range of cohesion energies, which enables it to dissolve numerous inorganic and organic substances. Carbon dioxide functions as a Lewis acid in complex formation with a variety of Lewis bases such as and unsaturated hydrocarbons, water, hydrogen peroxide, and the like. Certain other important properties of carbon dioxide are also shown in FIG. 2. Referring to FIG. 2, carbon dioxide exhibits a higher permeability rate than helium. This is due to its significantly higher cohesion energy chemistry.

Certain additional physical properties of carbon dioxide are shown in Table 1.

TABLE 1
Additional Physical Properties of CO₂
Physical Properties

Density of Gas - 1.58 g/m3 (0 C.)
Density of Liquid - 0.82 g/ml (−13 C.)
Density of SCF - 0.36 g/ml (31 C./73 atm)
Solubility in Water - 1.79 L CO₂ Gas/L H₂O (0 C.)

Although not wishing to be bound by theory, the present invention comprises the use of percarbonic acid, an oxy acid, which is postulated to posses sporicidal activity. More particularly, the combination of percarbonic acid and carbon dioxide will posses sporicidal properties in part due to the penentrant and carrier properties of carbon dioxide and the anti-microbial activity of the oxy-acid percarbonic acid.

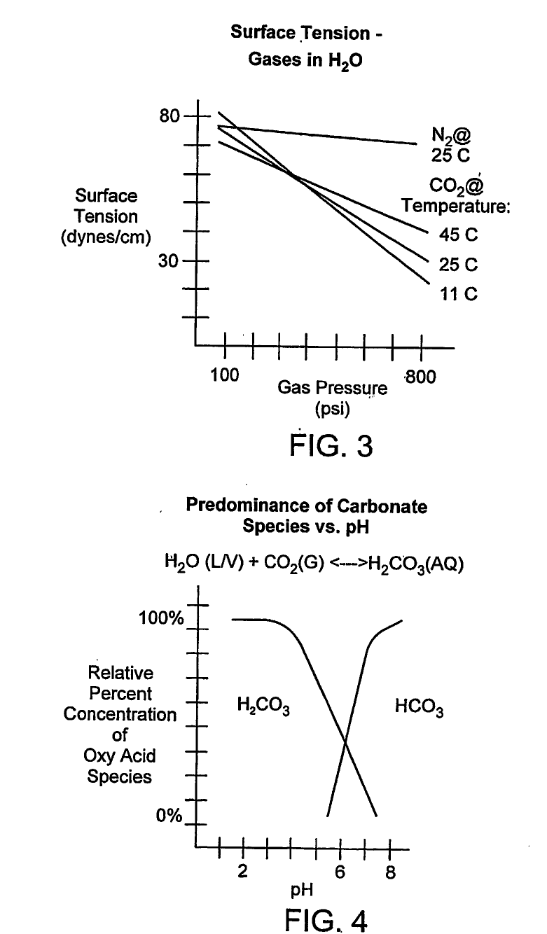

Now referring to FIG. 3, a graph is provided illustrating the relative effect of carbon dioxide gas on the surface tension of water. The effect of carbon dioxide is contrasted against the surface tension modifying properties of simple gases such as air and/or nitrogen. Thus, as the aqueous concentration of carbon dioxide increases, the surface tension of the resulting fluid decreases. A decrease in surface tension from approximately 75 dynes/cm to less than 30 dynes/cm can be achieved through the dissolution of significant quantities of carbon dioxide into water or hydrogen peroxide. The resulting fluid has a surface tension similar to that of common organic solvents. In contrast, liquid carbon dioxide has a surface tension of approximately 5 dynes/cm and supercritical carbon dioxide does not exhibit surface tension phenomenon. Surface tension reduction enhances treatment processes such cleaning, drying and dehydration mechanisms taught in the present invention.

Now, referring to FIG. 4, which provides a graph of carbonate species present a various pH, the carbonic acid complex predominates at pH values less than 6.5 and the bicarbonate complex predominates above 6.5. The use of carbonic acid or percarbonic acid in the present invention enables several aspects including acidification of spore cell water content. Carbonic acid is a weak acid that safely acidifies spores and treatment fluids and does not corrode like strong acids. Moreover, bicarbonate species may play a role in sequestering calcium ions as calcium carbonate from Ca-Dipicolinic acid complex present in spores during oxidation treatments herein, which enhances sporicidal activity. Following processing steps such as centrifugal dehydration, the acidity disappears without leaving corrosive residues.

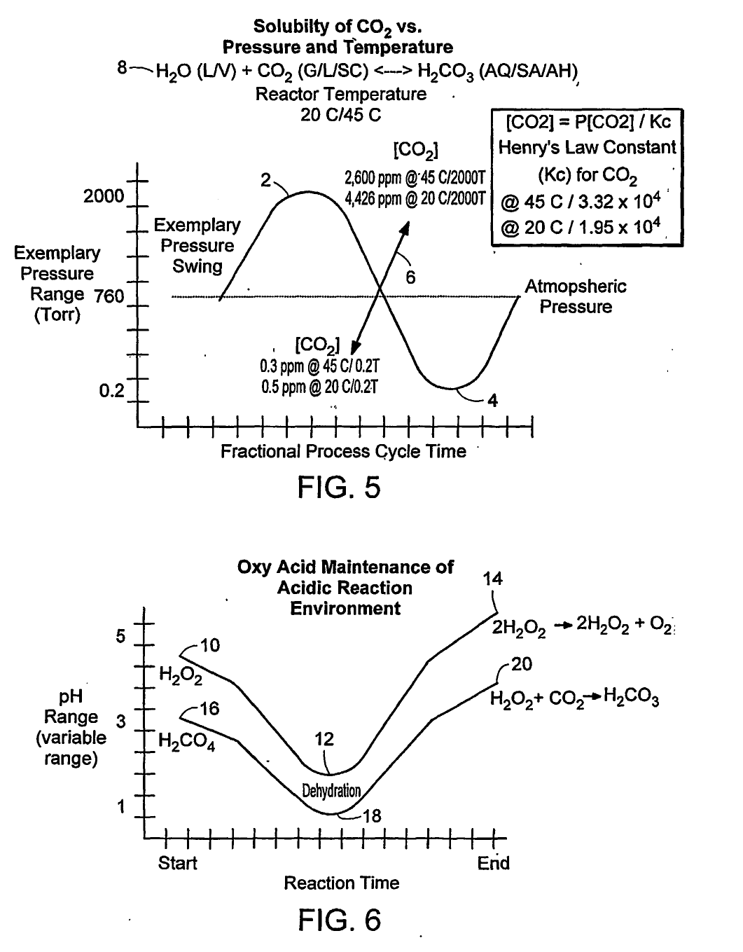

FIG. 5 is a graph showing the solubility behavior carbon dioxide in water in terms of Henry's law and Henry's Law constants for carbon dioxide in water during 1-5 an exemplary pressure swing adsorption-desorption cycle as used in the present invention. As shown in the figure, carbon dioxide is used to produce a range of concentrations from less than 1 ppm to more than 4000 ppm, depending upon pressure and temperature cycle (i.e., pressure swing adsorption-desorption cycle) employed herein. For example, as shown in FIG. 5 carbon dioxide under an exemplary super-atmospheric pressure of 2000 Torr (2) at a temperature between 20 C and 45 C can have an aqueous phase concentration of between 2,600 ppm and 4,426 ppm. During depressurization of the aqueous phase to an exemplary sub-atmospheric pressure of 0.2 Torr (4) and using the same temperature range, the carbon dioxide concentration is reduced to between 0.3 ppm and 0.5 ppm. Thus, one aspect of the present invention is to produce a range (6) of carbon dioxide concentrations to drive the carbonic or percarbonic acid formation and dissociation reaction (8) in aqueous (A), semi-aqueous (SA), and anhydrous (AH) reaction environments using a source of gas (G), liquid (L), or supercritical carbon dioxide (SC).

FIG. 6 is a graph showing the role PCA plays in maintaining an acidic reaction environment for UV-Plasma oxidative treatment processes employed herein. Acidic reaction environments are used herein to enhance activated hydrogen peroxide oxidation processes and to enhance sporicidal activity. As shown in FIG. 6, in the methods and use of the present invention, the PCA reaction begins with the introduction of the percarbonic acid complex (16), which exhibits a lower pH, followed by UV-Plasma and CPSA dehydration to remove water and carbon dioxide (18), and finally decomposition of the PCA into carbonic acid (20). In contrast, conventional hydrogen peroxide reactions typically begin with the introduction of hydrogen peroxide into the treatment chamber (10), followed by dehydration and concentration of hydrogen peroxide (12), and finally decomposition of hydrogen peroxide into water and oxygen (14).

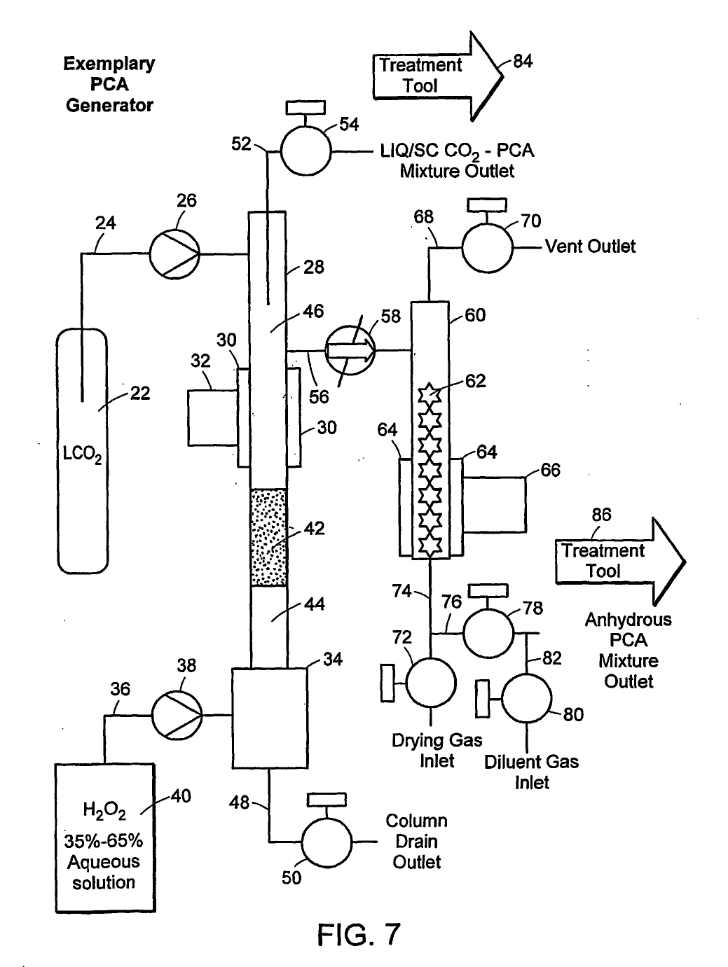

FIG. 7 gives an exemplary external PCA generator for generating an inorganic and non-aqueous PCA complex for use with the present invention. Referring to FIG. 7, an external PCA generator may comprise a commercial supply tank of liquid carbon dioxide (22), which is communicated via a pipe (24) and pump (26) to an extraction vessel (28). The pump (26) controls the pressure of the extraction vessel (28) to a pressure of between 650 psi and 2000 psi. The extraction vessel (28) contains a heater (30) and controller (32) to control the temperature of said extraction vessel (28) to a temperature of between 10 C and 60 C. Said extraction vessel (28) also contains a lower reservoir (34) which receives, via pipe (36) and pump (38), a supply of aqueous hydrogen peroxide (40). Said supply of hydrogen peroxide (40) may be any concentration between 35% and 65% by volume of hydrogen peroxide in water. Said extraction vessel (28) may also contain a hydrophobic membrane or plug (42) to prevent excessive water from being entrained from the lower hemisphere (44) into the upper hemisphere (46) of the extraction vessel (28). Furthermore, reservoir (34) is connected to a pipe (48) and valve (50), which allows an operator to remove extracted hydrogen peroxide contained in reservoir (34) and to dispose of this waste in a suitable drain. Said extraction vessel (28) is connected to an extract pipe (52) and extract valve (54), which is used to remove PCA from extraction vessel (28) for use in treatment processes described herein. Moreover, the extraction vessel may be connected, via an extract pipe (56) and metering valve (58), to a regenerative drying column (60) containing activated alumina (62). The drying column (60) also may contain a heater (64) and heater controller (66) to control the temperature of the dryer (60) to between 10C and 60C. The regenerative drying column (60) also may contain a vent/purge pipe (68) and vent/purge valve (70) and a drying gas inlet valve (72) and pipe (74) to allow for regeneration/reactivation of alumina (62) to remove residual moisture absorbed during PCA extract drying operations. Precision dried extract from the drying column (60) is withdrawn through pipe (76) and valve (78), which may be diluted using diluents such as nitrogen gas or preferably gaseous carbon dioxide delivered through valve (80) and dilution pipe (82). Diluted and precision dried PCA may be introduced to treatment operations as described herein.

In certain preferred aspects of the invention, the apparatus of FIG. 7 may be used to selectively extract a PCA complex by combining a quantity of aqueous hydrogen peroxide contained in reservoir (34) using a quantity of either liquid or supercritical carbon dioxide introduced into extraction vessel (28) to produce a semi-dry PCA extract (84). Furthermore, the apparatus of FIG. 7 provides a regenerative alumina dryer column (60) to further process a quantity of semi-dry PCA contained in extraction vessel (28) to remove residual carbonic acid using activated alumina (62) to produce a quantity of anhydrous PCA (86).

In certain other aspects, the invention provides methods of treating a substrate comprising contacting the substrate with a percarbonic acid composition under conditions conducive to substrate treatment. Certain non-limiting substrate treatments which are contemplated by the present invention include, surface modification, cleaning, disinfecting, sterilization, oxidation and combinations thereof. Certain particularly preferred substrate treatments include cleaning, disinfecting, sterilization and combinations thereof.

In certain preferred treatment methods of the invention which are suitable for cleaning a substrate, the method comprises contacting a substrate with the fluid comprising percarbonic acid under conditions conducive to removing contaminants from the substrate. Other preferred treatment methods include sterilizing methods in which a substrate is contacted with the fluid comprising percarbonic acid under conditions conducive to sterilizing the substrate.

Yet other preferred treatment methods include substrate modifying methods in which a substrate is contacted with a fluid comprising percarbonic acid under conditions conducive to substrate modification. Certain preferred substrate modification methods include those in which the substrate modification is an oxidative process. Thus, the method of surface oxidization ocmpirses the step of contacting the substrate with the fluid comprising percarbonic acid under conditions conducive to surface oxidation.

In yet other aspects, the invention provides methods of cleaning a substrate, the method comprising the step of contacting a substrate with a fluid comprising percarbonic acid under conditions conducive to removing contaminants from the substrate. Preferred cleaning methods include those in which the contaminant to be removed includes one or more of biological, organic, inorganic or particulate residues.

In certain other aspects, the invention provides methods of sterilizing a substrate, the method comprising the step of contacting a substrate with a fluid comprising percarbonic acid under conditions conducive to sterilizing the substrate. Certain preferred sterilizing methods of the invention include those methods suitable for use in cleaning and sterilizing the substrate, the method comprising the step of contacting a substrate with a fluid comprising percarbonic acid under conditions conducive to removing contaminants from the substrate and conducive to sterilizing the substrate.

Certain preferred methods of cleaning and sterilizing the substrate are capable of removing biological, organic, inorganic, and/or particulate residues. In particularly preferred methods of cleaning, disinfecting, and/or sterilizing substrates, substantially all of the contaminants, e.g., organic, inorganic, particulate, or biological residues present on the substrate, are removed from the substrate surface.

In certain other preferred cleaning, modification, or treatment methods of the invention, the substrate is a semiconductor, a (un)functionalized semiconductor wafer, an electronic packaging. Preferred cleaning or modifying methods for these applications include cleaning a surface to remove particles, polishing residues, photoresist residues, and other processing contaminants generated during semiconductor manufacture. In yet other applications, the cleaning and modifying methods are suitable for removing flux resiudes and other contaminants from beneath bonded flip-chip electronic packages (precision cleaning) and preparing (functionalization) said flip-chip device underside surfaces for under fill (coating/impregnation) operations.

Yet other preferred cleaning, modification, or treatment methods of the invention are suitable for use in cleaning, sterilization, functionalization and coating of textiles, clothing, and fabrics used for medical, industrial, and commercial cleaning market applications.

In certain preferred methods, the cleaning and sterilization occurs in sequential process steps. In yet other preferred methods the cleaning and sterilization steps are effected sequentially. Particularly preferred methods of cleaning and sterilizing substrates further disinfect the substrate. 33. The method of any one of claims 26-31, wherein the fluid comprises percarbonic acid and carbon dioxide.

In preferred cleaning, disinfecting and/or sterilizing methods of the invention, the fluid comprises percarbonic acid and liquid or supercritical carbon dioxide.

In yet other preferred cleaning, disinfecting and/or sterilizing methods of the invention, the fluid and the substrate are contacted with a plasma. Typically preferred plasmas include weakly ionized plasmas, UV irradiated plasmas, and weakly ionized plasmas that are concomitantly UV irradiated.

In certain preferred methods, pulsed ultraviolet plasma (UV-Plasma) is combined with PCA chemistries and centrifugal processing to provide efficient activation and utilization of photochemical and oxidative chemistries, as well as to provide enhanced vacuum-UV (VUV) drying using CPSA processes of the present invention.

Preferred weakly ionized plasmas include those which are generated by a single Rf source. More preferably the weakly ionized plasma has a pressure of between about 1 and about 600 Torr. An underdense plasma or weakly ionized plasma is defined herein as a weakly ionized gas-vapor mixture produced by a high frequency electric field (i.e., 100 KHz-13.56 MHz RF energy source) or pulsed high energy photon radiation in the UV range (i.e., Xenon or Xe₂ lamp source) under sub-atmospheric (vacuum) pressure conditions. Moreover, pulsed high energy UV radiation is used herein under sub-atmospheric, atmospheric and super-atmospheric pressure conditions to produce an ionized PCA complex and to enhance dehydration processes. Operating temperatures of between 10 C and 100 C may be used as well.

Certain preferred plasmas include those generated by irradiating a weakly ionized plasma with a UV radiation source. Typically preferred UV irradiatied weakly ionized plasma include those having a pressure of between about 0.1 atmospheres and about 2 atmospheres. An overdense plasma or pulsed UV plasma is created herein by irradiating a weakly RF ionized gas-vapor underdense plasma with high intensity pulsed UV radiation which drives the underdense plasma into a non-equilibrium condition (i.e., creates turbulence in the form of surface waves). UV-induced plasma turbulence provides a mechanism for the exchange of energy and momentum between electrons and ions.

Typically preferred cleaning, disinfecting and/or sterilizing methods of the invention, include those in which the fluid and the substrate are irradiated with UV light during at least a portion of the contacting step. In certain preferred methods of the invention, at least about 40% of the UV radiation has a wave length of less than 300 nm. More preferably, the UV radiation comprises between about 25-75% light having a wavelength of less than 300 nm, between about 5-40% light having a wavelength of between about 300 nm and about 750 nm, and about 5-40% light having a wavelength of at least about 750 nm.

In yet other preferred cleaning, disinfecting, or sterilizing methods of the invention in which the fluid and substrate are contacted concomitantly with UV irradiation, the UV radiation power is between about 50 to about 1500 watts. In certain preferred methods provided herein, the UV irradiation is continuous or intermittent. Typically preferred intermittent UV irradiation comprises pulsed UV irradiation of between about 1 and about 45 seconds per minute. More preferably, the intermittent UV irradiation comprises pulsed UV irradiation of between about 20 and 40 seconds per minute. In yet other preferred methods of the invention, the UV radiation is continuously applied to the substrate while the fluid is applied thereto.

In yet other preferred cleaning, disinfecting and/or sterilizing methods of the invention, the contacting step is conducted at between about 5° C. and about 200° C.

More preferably, the contacting step is conducted at between about 10° C. and about 150 C or between about 10° C. and about 100° C.

In certain other aspects, the invention provides cleaning, disinfecting and/or sterilizing methods in which the fluid has a percarbonic acid concentration of about 1 ppm to about 10,000 ppm when the fluid is in contact with the substrate. More preferably, the percarbonic acid concentration is between about 10 and about 5,000 ppm while the fluid is in contact with the substrate.

Preferred cleaning, disinfecting, and/or sterilization methods of the invention include those in which the substrate is contacted with the fluid comprising percarbonic acid for between about 1 minute and about 8 hours. More preferably, the cleaning, disinfecting, and/or sterilization methods of the invention include those in which the substrate is contacted with the fluid comprising percarbonic acid for about 30 minutes, about 1 hour, about 2 hours, about 3 hours, about 4 hours or about 6 hours. In certain preferred cleaning, disinfecting, and/or sterilization methods of the invention the contact time of substrate and fluid comprising percarbonic acid is between about 1 minute and about 6 hours, between about 1 minute and about 4 hours, or more preferably between about 1 minute and about 2 hours.

In certain other aspects, the invention provides methods of cleaning, disinfecting and/or sterilizing in which the fluid further comprises at least one additive. Typically preferred additives include those capable of modulating percarbonic acid reactivity and/or those capable of modulating plasma reactivity. Certain particularly preferred additives include those selected from the group consisting of inert gases, ozone, nitrogen, noble gases, carbon monoxide, carbon tetrachloride, carbon tetrafluoride, and mixtures thereof.

In certain preferred cleaning, disinfecting, and/or sterilization methods, the methods further comprise a drying step after the substrate was contacted with the fluid comprising percarbonic acid. Although any traditional drying process typically used in substrate cleaning, disinfecting and/or sterilization processes are contemplated for use in the methods of the invention, certain preferred post-treatment drying processes are discussed infra.

The cleaning, disinfecting, and/or sterilization methods of the invention are suitable for cleaning, disinfecting, and/or sterilizing any substrate. Certain preferred substrates which are particularly suitable for the methods of the invention include, but are not limited to substrates composed of metal, ceramic, glass, polymers, resins, or a combination thereof. Preferred metallic substrates include stainless steel, platinum, iridium, palladium, nickel, gold, titanium, zirconium, inconel, cobalt steel, aluminum, copper, zinc, bronze, metal plating, metal foams, magnetic substrates, or combinations thereof.

Preferred polymeric or resin substrates include, but are not limited to, those composed of polyethylene, polypropylene, neoprene, Buna-N, Butyl Rubber, silicones, Viton, EPDM, polyurethane, polyetheretherketone, nylon, Teflon, Tyvek, biocompatible fabrics and polymers, cellulose acetates, PVC, CPVC, polycarbonate, Delrin, polyetherimide, polyamide, polyimide, and combinations thereof.

Certain preferred glass or ceramic substrates which are suitable for cleaning, disinfecting, and/or sterilizing by the methods of the invention include substrates composed of silicon dioxide, borosilicate, quartz, alumina, silica, borosilicate, zirconium oxide, silicon carbide, boron nitride, magnetic ceramics, superconductive ceramics, or a combination thereof.

Although substrates intended for any purpose can be cleaned, disinfected, and/or sterilized by the methods of the invention, typically preferred substrates include medical devices, biomedical implants, semiconductor wafers, electronic devices, optical element, or composite articles. Particularly preferred substrates for the cleaning, disinfecting, and/or sterilization methods of the invention include medical devices or more preferably reusable endoscopes, catheters, and medical devices comprising one or more long, narrow lumens.

In certain aspects, the invention provides cleaning, disinfecting, and/or sterilization methods comprising the steps of
applying a translational force to the substrate; and
contacting a substrate with a fluid comprising percarbonic acid under conditions conducive to removing contaminants from the substrate.

In yet other aspects, the invention provides cleaning, disinfecting, and/or sterilization methods which comprise the steps of
agitating the substrate with ultrasound; and
contacting a substrate with a fluid comprising percarbonic acid under conditions conducive to removing contaminants from the substrate.

Certain preferred cleaning, disinfecting, and/or sterilization methods comprising applying a translational force or ultrasound to a substrate include those methods which comprise the steps of
applying a translational force and ultrasound to the substrate; and
contacting a substrate with a fluid comprising percarbonic acid under conditions conducive to removing contaminants from the substrate.

Yet other preferred cleaning, disinfecting, and/or sterilization methods comprising applying a translational force to a substrate include those in which the fluid is contacted with the substrate while the translational force is applied thereto.

Certain other preferred cleaning, disinfecting, and/or sterilization methods comprising applying a translational force or ultrasound to a substrate include those in which the contaminants are biological, organic, inorganic, or particulate residues.

Certain preferred cleaning, disinfecting, and/or sterilization methods comprising applying a translational force or ultrasound to a substrate include those sterilization methods which comprise the steps of
applying a translational force to the substrate; and
contacting a substrate with a fluid comprising percarbonic acid under conditions conducive to sterilizing the substrate.

Certain preferred cleaning, disinfecting, and/or sterilization methods comprising applying a translational force or ultrasound to a substrate include those disinfection methods which comprise the steps of
agitating the substrate with ultrasound; and
contacting a substrate with a fluid comprising percarbonic acid under conditions conducive to removing contaminants from the substrate.

Certain preferred cleaning, disinfecting, and/or sterilization methods comprising applying a translational force or ultrasound to a substrate include those disinfection or sterilization methods which comprise the steps of
applying a translational force and ultrasound to the substrate; and
contacting a substrate with a fluid comprising percarbonic acid under conditions conducive to removing contaminants from the substrate.

Certain preferred cleaning, disinfecting, and/or sterilization methods comprising applying a translational force or ultrasound to a substrate include those cleaning and sterilization methods which comprise the steps of
applying a translational force to the substrate; and
contacting a substrate with a fluid comprising percarbonic acid under conditions conducive to removing contaminants from the substrate and conducive to sterilizing the substrate. More preferably, the cleaning and sterilization method comprises contacting the fluid with a substrate while the translational force is applied thereto. In certain preferred embodiments, the cleaning and disinfecting methods are capable of removing contaminants selected from biological, organic, inorganic, or particulate residues from a substrate surface.

Certain preferred translational forces which are suitable for use in the cleaning, disinfecting, and sterilization methods of the invention include bi-directional and different spin orientation centrifugal energy is employed to produce Coriolis forces which enhance penetration into and physical cleaning or sterilization of complex substrate geometries such long lumens and accelerate dehydration of PCA complexes and substrate surfaces following cleaning processes. Although not wishing to be bound by theory, centrifugal energy and resultant Coriolis forces are believed to enhance UV-Plasma processing. Vacuum and UV-Plasma fluids behave as non-newtonian fluids, exhibiting heterogeneous energy densities, diffusion characteristics, and mixing patterns. Such complex fluids do not obey Newton's law of viscosity, exhibiting shear thinning and viscoelastic behavior when mixed using mechanical means such as a fluid mixing impellor or increased gas flow.

In preferred methods of the invention which apply a translational force to the substrate, the translational force is a centripetal or Coriolis force. In yet other preferred methods of the invention which apply a translational force to the substrate, include those methods in which the fluid comprises percarbonic acid and carbon dioxide, or more preferably percarbonic acid and either liquid or supercritical carbon dioxide. In still other preferred methods, the fluid and the substrate are contacted with a plasma which may be selected from weakly ionized plasma, UV irradiated weakly ionized plasma and the like.

Already discussed herein, carbon dioxide can penetrate or plasticize organic structures much faster than simple air gases such as oxygen and nitrogen. There is evidence in the literature that some spores readily uptake CO₂ and this may cause germination to initiate faster. Access to the interior of a spore is critical for complete deactivation and is believed to be a sporicidal factor in the present invention. Moreover there is evidence in the literature that carbon dioxide can be used to sequester calcium sources from biological entities. The spore complex called Calcium-Dipicolinic acid or (Ca-DPA) plays a significant role in a spore resistance to heat and other environmental stresses. As such one theory for sporicidal action of PCA herein is that the Ca-DPA complex is partially or completely oxidized, freeing the calcium ion for sequestration by carbon dioxide, discussed in the following section.

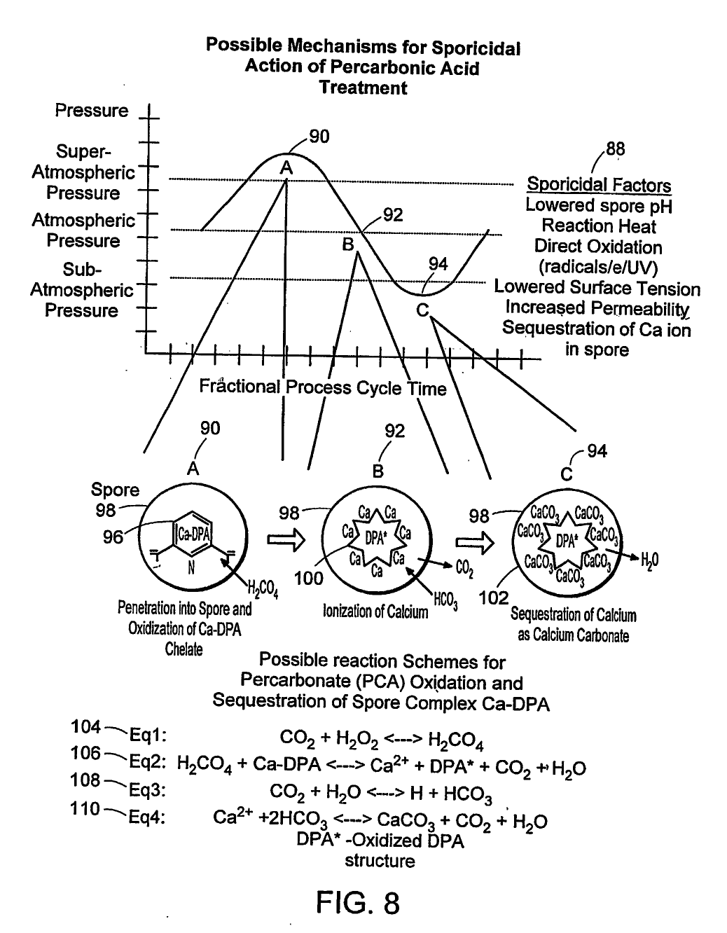

Although not wishing to be bound by theory, FIG. 8 gives is a schematic diagram showing the possible mechanisms for the sporicidal action of PCA as used in the present invention. Referring to FIG. 8, sporicidal actions involving the chemistries and processes of the present invention most probably include a combination of factors (88). As shown in the figure, these may include low pH, reaction heat supplied externally or heat generated during anhydrous peroxide decomposition reactions, UV-Plasma-PCA oxidation reactions, lowered surface tension, increased permeability attributed to carbon dioxide, and possibly the chemical sequestration of calcium ions. Calcium is a major constituent of Ca-Dipicolinic acid (Ca-DPA) complex contained in spores such as B. subtilis and is thought to be a principle factor in this resistant spore's ability to withstand extremely harsh treatments such desiccation or dry heat resistance. A novel and potential mechanism is proposed herein that involves the sequestration of calcium as calcium carbonate during exemplary CPSA-PCA treatment cycles herein. This mechanism is thought to enhance the sporicidal action of the present invention by altering the chemical and physical resistance of such spores. This mechanism is proposed as follows.

Referring to FIG. 8, certain preferred processes of the present invention involves three distinct sequences, the combination of which comprises a centrifugal pressure swing adsorption-desorption (CPSA) PCA treatment cycle. These sequences comprise a super-atmospheric pressurization step, shown as sequence A (90), depressurization to ambient pressure, shown as sequence B (92), and depressurization to sub-atmospheric pressure, shown as sequence C (94). Now referring to these sequences individually, in sequence A (90) the Ca-DPA complex (96) contained within a spore (98) is permeated and reacted with PCA which completely or partially oxidizes the complex (96). Following this, in sequence B (92), an oxidized Ca-DPA complex (100) and spore (98) liberates free calcium ions from the complex (100) as well as carbon dioxide gas from solution, which itself drives the formation of bicarbonate ion and calcium ions. Finally, in sequence C (94), liberated calcium ions and bicarbonate ions react to form calcium carbonate (102), removing water as by-product. Proposed reaction schemes for the sequestration process described above are given as Eq. 1.—PCA formation (104), Eq. 2—PCA Oxidation of Ca-DPA (106), Eq. 3—Bicarbonate ion formation (108), and Eq. 4—Calcium sequestration (110).

In certain other preferred cleaning, disinfecting and/or sterilization methods of the invention, UV-Plasma is contacted with the percarbonic acid to expedite the cleaning and sterilization treatment processes and to perform functionalization and coating following such treatments.

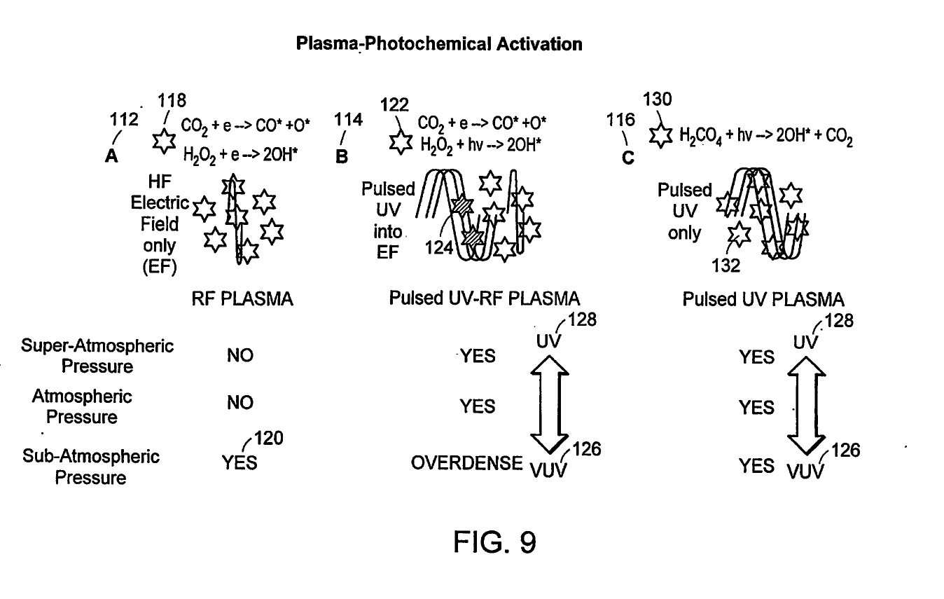

Now referring to FIG. 9, a schematic illustrating the different types of UV-Plasma used in the present invention is provided. Three preferred types of plasma which are used to activate PCA and combined CPSA-PCA treatment processes, include RF Plasma Only (112), Pulsed UV-RF Plasma (114), and UV Plasma (116).

RF Plasma Only (112) is comprised of excited radicals, ions, and neutrals (118), produced under sub-atmospheric pressure conditions (120) using a suitable high frequency plasma energy source. Rf only plasma is referred to herein as a weakly ionized plasma. These species may include carbon monoxide radicals, atomic oxygen, and hydroxyl radicals. The source for this type of plasma may be derived from, for example, a power supply providing an electric field of between 100 KHz and 13.56 MHz and a power output of between 30 watts and 3000 watts. This type of plasma is considered weakly ionized or underdense. However a suitable high frequency plasma source may be used in the present invention under atmospheric and super-atmospheric pressure conditions to provide what is termed an atmospheric glow discharge or corona discharge. Such discharges provide additional cleaning and sterilization energy derived from the presence of strong electric and the production of plasma species such as ozone.

Pulsed UV-Rf plasma (122) is comprised of similarly charged species (122) as RF only plasma as well as more energetic species (124) produced under sub-atmospheric, atmospheric, and super-atmospheric pressure conditions. Energetic species include carbon monoxide radicals, atomic oxygen, and hydroxyl radicals, among others. The source for this type of plasma may be derived from, for example, a power supply providing an electric field of between 100 KHz and 13.56 MHz and a power output of between 30 watts and 3000 watts, into which a pulsed high energy source of ultraviolet radiation (UV) is introduced. Pulsed high energy UV sources include a Xenon (Xe) light source (i.e., Model RC250, Xenon Corporation, Woburn, Mass.) which can produce up to 2000 watts or more of predominantly UV photons as well as some Visible (VIS) and Infrared (IR) photon energies. This type of plasma is considered overdense plasma. UV pulsing allows the activation process to extend into the atmospheric and super-atmospheric pressure regime to provide a spectrum of vacuum ultraviolet energy (VUV) (126) and UV energy (128) under all CPSA process conditions described herein.

UV plasma (116) is comprised of similarly excited species (130), although much more specific to the type of UV absorption characteristics of a particular substance. Thus, for example, excited species generated by irradiation of percarbonic acid with UV radiation may be different from other plasmas generated using other energy sources. The source for this type of plasma may be derived from, for example, a pulsed high energy UV source such as Xenon (Xe) light source (i.e., Model RC250, Xenon Corporation, Woburn, Mass.) which can produce up to 2000 watts or more of predominantly UV photons as well as some Visible (VIS) and Infrared (IR) photon energies. PCA complexes (132) readily absorb UV-VIS photons to produce hydroxyl and perhydroxyl radicals. As in a pulsed UV-Rf plasma above, UV pulsing allows the activation process to extend from the sub-atmospheric to super-atmospheric pressure regimes to provide a spectrum of vacuum ultraviolet energy (VUV) (126) and UV energy (128) under all CPSA process conditions described herein.

As discussed above, overdense plasma is created herein by irradiating a weakly ionized gas-vapor plasma or underdense plasma with high intensity pulsed UV radiation, which drives the underdense plasma into a non-equilibrium condition (i.e., creates turbulence in the form of surface waves). UV-induced plasma turbulence provides a mechanism for the exchange of energy and momentum between electrons and ions.

Applying pulsed energy in the form of UV photons in combination with weakly ionized plasmas overcomes the localized shielding effect of complex substrate structures and compositions. Overdense plasmas are used in the present invention to provide a more uniform and dense energy treatment environment for substrates. A complement of photons, electrons, ions, neutrals, and intense pulsed UV radiation augment centrifugal pressure swing adsorption-desorption (CPSA) and percarbonic acid treatment processes herein. Weakly ionized plasmas serve as energetic treatment media that catalyze UV photochemical processes by providing activation energy and sustaining energetic species. CPSA enhances centrifugal, plasma, and photochemical processes herein to enhance cleaning, sterilization, coating and impregnation of substrates. Moreover, the judicious application of external heat is also taught herein to enhance diffusion rates, increase reaction rates, increase penetration rates, and to provide improved substrate drying.

Weakly ionized plasmas and pulsed UV energy, or both, drive oxy acid oxidation processes by producing treatment species such as plasma radicals, ions, neutral species and intermediate oxidation compounds. Moreover, initial oxidation products may be reformed and recycled into treatment reactions, similar to catalytic processes, using UV-Plasma. For example, the presence of excess carbon dioxide in the present invention enhances oxidative treatment by consuming water during UV-Plasma dehydration sequences to form hydrogen peroxide by-products such as hydroxyl radicals and perhydroxyl radicals, which increases the efficiency of the oxidation processes of the present invention as compared to conventional plasma-peroxide treatments.

Certain preferred treatment methods of the invention include those methods which comprise treating a substrate with a combination of percarbonic acid and a plasma. One or more UV-Plasma combinations such as those described above are used in the present invention to selectively activate, functionalize, or coat/impregnate surfaces, although a final sterilization sequence may occur again following such finishing treatments. For example, carbon dioxide and other gases and additives may be used with an underdense or overdense plasma to impart beneficial changes to a substrate surface such as implanting functional chemistries, increasing wetability, and imparting hygroscopic properties, among many other possible surface functionalities. This aspect of the present embodiment prepares the substrate surfaces for subsequent coating or impregnation steps, which may be implemented in the same treatment chamber as cleaning and sterilization steps, and described more fully below. Still moreover, UV-Plasma combinations may be used selectively with surface coating or impregnation agents and dense fluids to activate and covalently bond beneficial substances to dry, clean, sterile, and functionalized substrate surfaces. Substances may include anti-coagulants, lubricants, water repellents, and drugs. Such surface coatings or impregnations provide improved lubricity, longevity, biocompatibility, or water repellency, among other beneficial biomedical device characteristics.

Still moreover and as discussed above, the present invention teaches the use of a weakly ionized plasma under sub-atmospheric pressure conditions using a high voltage and high frequency plasma source. However, under atmospheric and super-atmospheric pressure conditions the exemplary high voltage high frequency source taught herein may be used to enhance CPSA/PCA reactions by providing an intense electric field within the treatment chamber. The surface tensions of liquids, for example the PCA complex, can be significantly reduced by the presence of applied electric fields of sufficient intensity at elevated pressures.

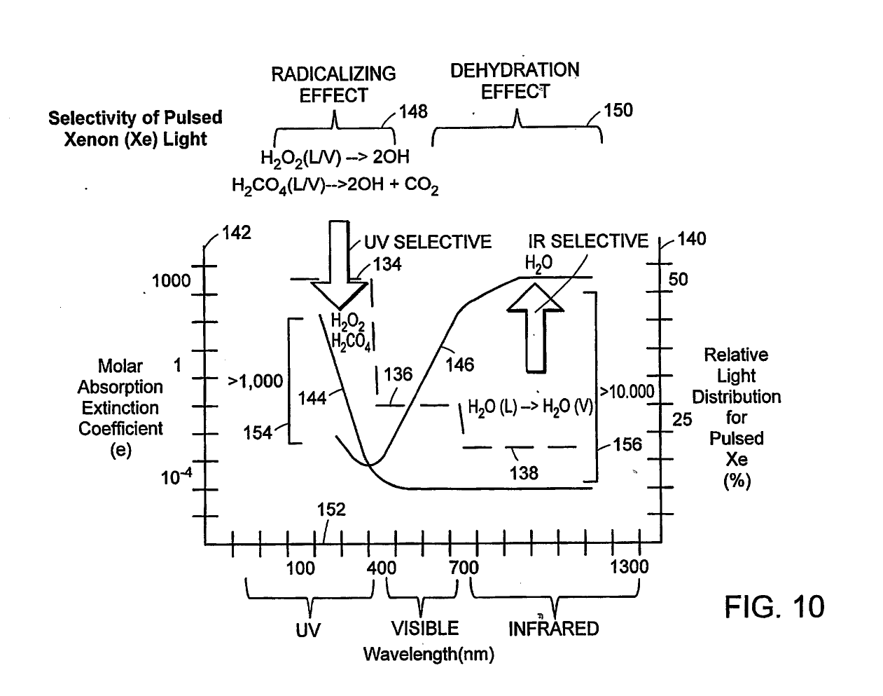

FIG. 10 is a schematic showing certain preferred pulsed UV-VIS light that is suitable for use in the treatment methods of the invention for selective activation of percarbonic acid and carbonic acid (e.g., complexes of water with either hydrogen peroxide or water). Referring to FIG. 10, PCA complexes and carbonic acid complexes react differently, and beneficially so, to the pulsed UV radiation used herein. The pulsed UV radiation comprising a xenon light source produces a spectrum of photons comprising approximately 50% UV light (134), approximately 30% visible light (136), and approximately 20% of infrared radiation (138). This distribution profile represented by the dashed lines (134, 136, and 138) is shown on the leftmost vertical axis (140).

The molar extinction coefficients for PCA and water, represented by the rightmost vertical axis (142) are inversely relational with respect to UV-VIS-IR absorption. The hydrogen peroxide absorption profile (144) shows that hydrogen peroxide strongly absorbs UV radiation and weakly absorbs VIS and IR radiations. By contrast, the water absorption profile (146) shows weak UV absorption and stronger VIS and IR radiation absorption. As such, in the present invention photons are used selectively to radicalize (148) peroxide and simultaneously produce a dehydration effect (150). This photon spectrum is represented by the horizontal axis (152). The selectivity for peroxide is as much as 1000× (154) more in the UV region than the VIS-IR region and the selectivity for water is as much as 10,000× (156) more in the VIS-IR region than the UV region. As such, UV light as described and used herein produces a powerful and highly selective radicalizing and dehydration effects.

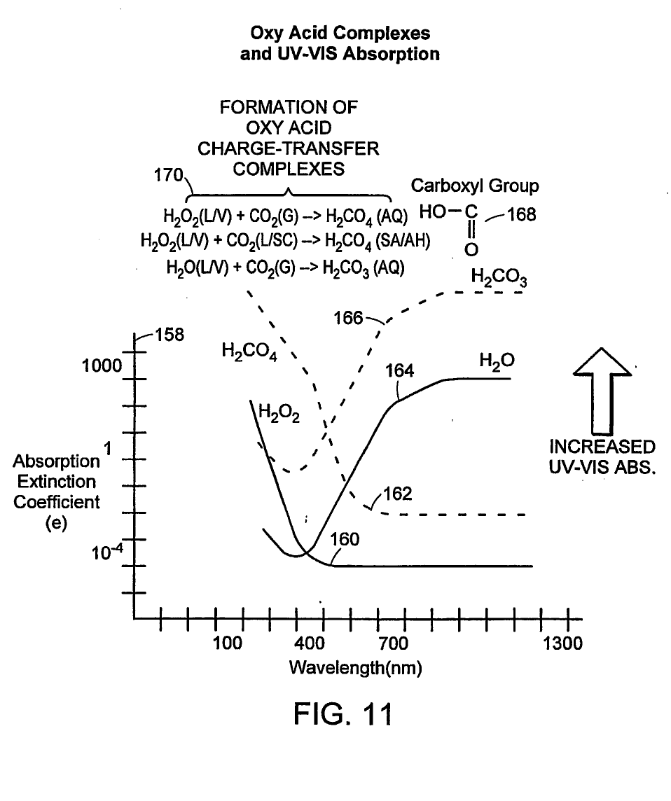

FIG. 11 gives a graph showing the beneficial impact upon UV-VIS absorption characteristics shown in FIG. 10 for hydrogen peroxide complexed with carbon dioxide. Referring to FIG. 11, carbon dioxide-complexed solutions exhibit increased UV-VIS light absorption coefficients—an indication of the formation of charge-transfer complexes. For example, as shown in FIG. 11, the light absorption profile, represented by the rightmost vertical axis (158), for hydrogen peroxide (160) are expanded into both the UV and VIS regions due to the formation of the PCA complex (162). Similarly, the light absorption profile for water (164) is also expanded into both the UV and VIS regions due to the formation of the carbonic acid complex (166). Although not wishing to be bound by theory, the increase in UV/Vis absorbance is postulated to be due to the formation of the carboxyl group (168) of percarbonic acid and carbonic acid. The various charge-transfer complexes (170) are given in FIG. 11. Thus, complexing is used herein to more efficiently use UV-VIS light to produce enhanced radicalization and dehydration.

Moreover, carbon dioxide-based complexes may improve the production of hydroxyl and perhydroxyl radicals. For example, photo-Fenton reactions produce hydroxyl radicals by reacting with hydrogen peroxide and UV radiation as follows:

| Photo-Fenton reaction | Wavelength |
|---|---|
| H₂O₂ + λv → 2OH | 250 < λ < 300 nm |
| Fe²⁺ + H₂O₂ → OH + OH⁻ + Fe³⁺ | |
| Fe³⁺ + OH⁻ → Fe(OH)²⁺ | |
| Fe(OH)²⁺ + λv → OH + Fe²⁺ | λ = 350 nm |

It is believed that photo-Fenton reactions involve the formation of a charge-transfer complex (Fe(OH)²⁺) which uses light quanta much more efficiently. As such, we believe one advantage of the present invention is that oxy acid complexes and intermediates used herein produce more hydroxyl radicals than conventional photo-hydrogen peroxide reactions using a Fenton like reaction scheme, with carbon dioxide recycled within the process as various carbonate species.

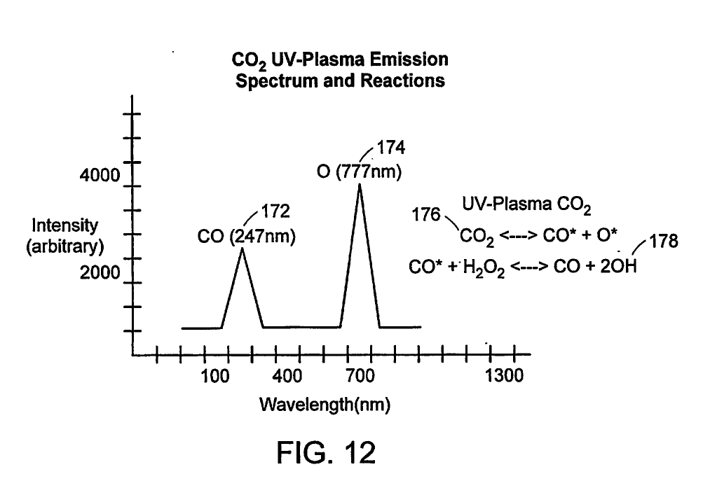

FIG. 12 gives a graph showing two important emission lines for plasma carbon dioxide. Referring to FIG. 12, carbon dioxide exhibits unique plasma emission spectra that are not that dissimilar to carbon tetrafluoride (CF₄) plasma, a powerful ultraviolet (UV) and fluoro-radical plasma. As shown in FIG. 12, CO₂ produces a germicidal UV emission (172) at approximately 250 nm and an oxygen atom emission (174) at 777 nm via the excitation reaction (176). A CO₂ plasma produces UV radiation (exhibiting a bluish color) plus Atomic Oxygen (UVO), which is a catalytic treatment for oxidizing organic and inorganic contaminants to water and simple gases. Carbon dioxide contributes to the formation of hydroxyl radicals through the reaction (178) between carbon monoxide radicals and with hydrogen peroxide. Moreover, small amounts of various gases may be added to carbon dioxide gas to enhance its overall plasma characteristics. For example, the addition of nitrogen (N₂) can improve radical scavenging processes and small amounts of Argon (Ar) can improve electron bombardment processes. Still moreover, the addition of compounds such as CF₄ will broaden the carbon dioxide plasma cleaning and sterilization effect.

In yet another aspect, the invention provides treatment methods, or more preferably cleaning, disinfecting, and/or sterilization methods in which a bi-directional and different spin orientation centrifugal energy is applied to the substrate to generate Coriolis forces. Although not wishing to be bound by theory, the application of Coriolis force is believed to enhance penetration into and physical cleaning or sterilization of complex substrate geometries such long lumens and accelerate dehydration of PCA complexes and substrate surfaces following cleaning processes. Moreover, centrifugal energy and resultant Coriolis forces enhance UV-Plasma processing.

Vacuum and UV-Plasma fluids behave as non-newtonian fluids, exhibiting heterogeneous energy densities, diffusion characteristics, and mixing patterns. Such complex fluids do not obey Newton's law of viscosity, exhibiting shear thinning and viscoelastic behavior when mixed using mechanical means such as a fluid mixing impellor or increased gas flow. This creates problems in conventional and static plasma treatments because treatment conditions vary from one locale to the next within the treatment zone. Complex substrates perturb electromagnetic fields in conventional plasmas, which creates uneven energy densities near or around complex substrate surface geometries, which do not propagate into small cavities. As such, centrifugation is uniquely used herein with a vacuum fluid or UV-Plasma to induce newtonian-like behavior, which greatly enhances diffusional behavior. This is accomplished by moving the entire substrate within the non-newtonian fluids with various angular velocities and in different directions and orientations.

In certain preferred methods, applying pulsed energy in the form of UV photons (e.g., overdense plasma) overcomes the localized effect of substrate structure and composition associated with weakly ionized plasmas. In this instance, centrifugation is used herein to homogenize plasma reactants and substrates within the treatment system, providing a uniform and optimized treatment environment. Still moreover, centrifugation or rotation of reaction fluid environments creates Coriolis forces as a resultant force which propels treatment agents into the smallest spaces in a transverse direction to centrifugal force which provides enhanced flux, penetration, and physical separation. Moreover, centrifugal force is used herein to significantly enhance UV-Plasma reactions such as dehydration. This enhancement effect is produced, in part, because of the formation of dynamic thin films on substrate surfaces experiencing centrifugal and Coriolis forces, which exhibit superior mass transfer phenomenon as compared to static plasma processes. As such, the present invention mechanically manipulates plasmas to enhance treatment phenomenon herein. Manipulation of underdense plasmas have been investigated previously for diverse applications such as aircraft drag reduction, improved ion implantation uniformity, and improved heat dissipation (see references below).

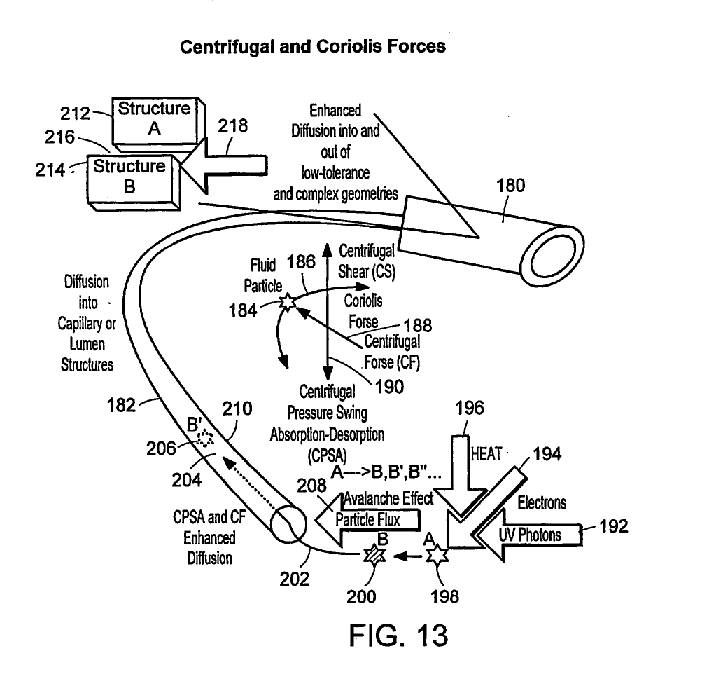

FIG. 13 gives a schematic diagram of a complex device experiencing centrifugal and Coriolis forces. Now referring to FIG. 13, an illustrative complex medical device (180) has a tubular structure and contains a long narrow capillary or lumen (182). The complex device represented by this diagram is a challenging cleaning and sterilization application because it is difficult to 1) diffuse cleaning and sterilization agents into and through the lumen (182) and 2) remove these treatment agents and by-products from such structures. As such, the present invention utilizes centrifugal force, which creates resultant Coriolis forces, to significantly enhance all physicochemical aspects of the present invention including mixing of plasma fluids, diffusion of active species into complex structures, dehydration of PCA complexes, drying of treated substrates, functionalization of surfaces, and coating or impregnation of surfaces.

For example, in the present invention a treatment fluid particle (184) is subjected to fluid shearing and Coriolis forces (186), caused by the substrate moving with an angular velocity through space, and a centrifugal force (188) which increases with increasing diameter and angular velocity. As shown in FIG. 13, the fluid shearing and Coriolis forces can altered in both direction and magnitude by changing the direction of rotation and/or angular velocity. Moreover, while experiencing centrifugal and Coriolis forces, the exemplary fluid particle (184) may be subjected to a pressure swing adsorption-desorption cycle (190), called centrifugal pressure swing adsorption-desorption (CPSA) herein and discussed in more detail below.

Certain preferred UV-Plasma treatment agents such as photons (192) and electrons (194), as well as external reaction heat (196), are optionally applied to this dynamic system to provide enhanced treatment reactions. For example, as shown in FIG. 13, an exemplary fluid particle A (198), which may be a PCA complex, is simultaneously subjected to the aforementioned thermal, electronic, and photonic energies. This results in the activation of the PCA complex as fluid particle B (200), which may be an activated PCA substance such as a hydroxyl radical. Simultaneously occurring with this activation sequence, the substrate represented by the exemplary complex device (180) moves through the activated fluid particle B (200) driving or diffusing said particle along a trajectory (202) into the interior of said exemplary lumen (182). Within the interior surfaces (204) of the exemplary lumen (182), the activated particle (200) contacts interior surfaces containing unwanted contaminants such as soils and bacteria, degrading or decomposing into neutral species (206) such as water and carbon dioxide. This process is continuously occurring with literally millions of activated particles (200) entering and diffusing along and through the exemplary lumen device (182). This results in an avalanche of activated particles or particle flux along the exterior surfaces (210) and interior surfaces (204) of the exemplary complex device (180). Furthermore, the exemplary complex device (180) may contain internal complex substrate features, represented as structure A (212) and structure B (214), which may have a low-tolerance gap (216). The present embodiment overcomes this challenge by enhancing diffusion (218) of activated cleaning and sterilization agents into and out of said complex features.

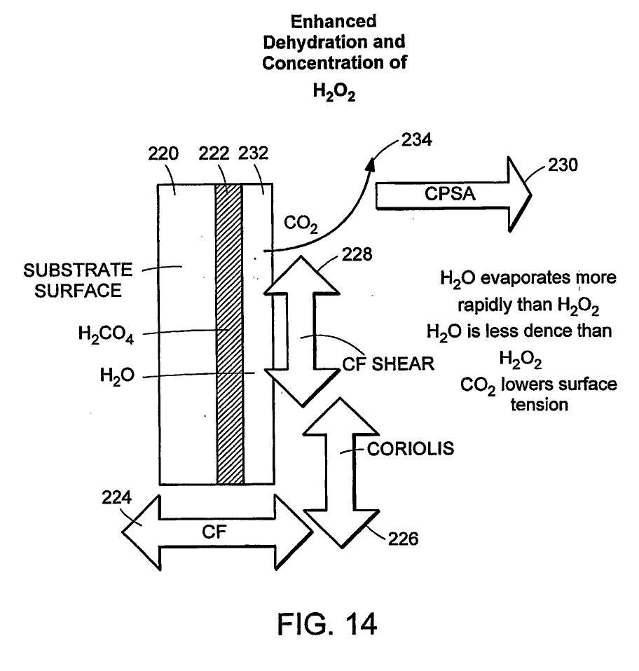

FIG. 14 is a graphical representation of another aspect of the invention. That is, FIG. 14 provides an illustration of the dehydration of the PCA complex. Referring to FIG. 14, an exemplary substrate surface (220), for example as described in FIG. 13 (204) above, contains a film of PCA (222). Under combined mechanical actions of centrifugal force (224), resultant Coriolis forces (226), centrifugal fluid shear (228), and CPSA (230) processes, said PCA film (222) rapidly separates or stratifies into anhydrous hydrogen peroxide (222), water vapor (232), and carbon dioxide gas (234) as shown in the figure. Centrifugal processes such as used herein exploit the evaporation properties of thin films containing compounds having different densities and volatilities. In the present invention, both water vapor and carbon dioxide are readily diffused out of thinned PCA films (222), produced by centrifugal shearing or thinning forces. Moreover, carbon dioxide present in the thin film reduces surface tension which enhances evaporation of thin films from surfaces Still moreover, CPSA processes (230) which are described more fully below enhance the centrifugal dehydration process thus described by providing diffusion gradients which are directed toward (adsorption) or away (desorption) from the shearing surfaces (220).

In yet another aspect, the invention provides for the use of pressure swing adsorption-desorption in the treatment methods provided herein. Certain preferred pressure swing adsorption-desorption processes include centrifugal pressure swing adsorption-desorption (CPSA). CPSA enhances centrifugal, plasma, and photochemical processes herein to improve cleaning, sterilization, drying, coating and impregnation of substrates. Moreover, external heat may be applied judiciously to CPSA processes herein to enhance diffusion rates, increase treatment oxidation reaction rates, increase penetration rates, and provide improved drying.

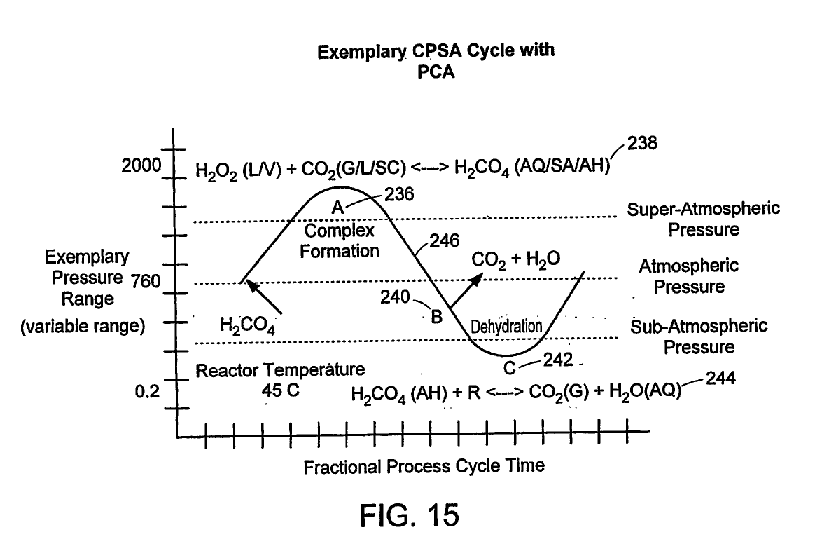

FIG. 15 gives an exemplary CPSA cycle using PCA, which represents a fraction of the total process cycle time. Referring to FIG. 15, under super-atmospheric pressure conditions, the PCA complex is formed, denoted as point A (236), which is forced into substrate pores and capillaries using centrifugal forces described herein. CO₂ gas is added selectively herein to cause super-saturation of PCA. As shown in the equation (238), CO₂ over-pressurization creates an excess of PCA, which under mechanical actions implemented herein, will uniformly coat and impregnate substrate surfaces and contaminants. Following this sequence, CPSA is used with vacuum to concentrate anhydrous peroxide on or within substrate surfaces and contaminants, during which water and carbon dioxide are selectively extracted from a substrate surface, denoted as point B (240). Finally, dehydrated PCA reacts completely with unwanted substrate residues under sub-atmospheric pressure to form water vapor and carbon dioxide gas, denoted as point C (242). As shown by the equation (244), removal of excess carbon dioxide and water vapor drives this reaction to completion. The exemplary CPSA cycle (246) shown in FIG. 15 ranges between 0.2 T and 2000 T and may be repeated one or more times during a particular treatment process as necessary to achieve a desired cleanliness. Moreover, and as already discussed herein, UV-Plasmas are used selectively during a CPSA cycle to enhance treatment processes described herein.

Operating pressures for the CPSA cycle may range between sub-atmospheric pressure (e.g., 10⁻⁴ Torr) and super-atmospheric pressures as high as 250 atm or more, in which case, dense fluid-PCA mixtures predominate. A particular CPSA pressure cycle used in the present invention should be tempered against the sensitivity of or materials compatibility issues associated with a particular substrate. For example, bulky metallic substrates may be processed using a cycle of between 250 mT to 250 atm, or more, without materials compatibility problems. However, sensitive medical substrates having features such as those found in endoscopes (having a composition of metals, plastics, polymers, sealed cavities, lumens, optics etc.) should be processed between 250 mT and 3 atm to prevent damage.

Other aspects of the invention comprise treatment methods which are carried out in an apparatus for cleaning or sterilizing a substrate with percarbonic acid comprising a cleaning chamber, a UV irradiation source, an electrical field generator, a device capable of applying a translational force to the substrate, and a percarbonic acid generator or percarbonic acid source. The apparatus provided herein are suitable for use in treatment methods in which UV-plama and centrifugal forces are applied to a substrate in combination with a fluid comprising percarbonic acid or a mixture of percarbonic acid and carbon dioxide.

In yet other preferred aspects, the invention provides a monitoring process, monitoring and management system, and a control system, with which the treatment methods of the invention are conducted. Certain preferred monitoring processes of the invention include those processes comprising the steps of
providing a test substrate having at least one chemical or biological contaminant deposited thereon;
measuring the UV-Vis spectrum of the test substrate prior to cleaning or sterilizing;
contacting the test substrate with the fluid comprising percarbonic acid under conditions conducive to cleaning or sterilizing the substrate;
measuring the UV-Vis spectrum of the test substrate periodically during and after contacting the test substrate with the fluid; and
comparing the periodic UV-Vis spectra against the pre-cleaning or pre-sterilizing UV-Vis spectrum to monitor the cleaning or sterilization process.

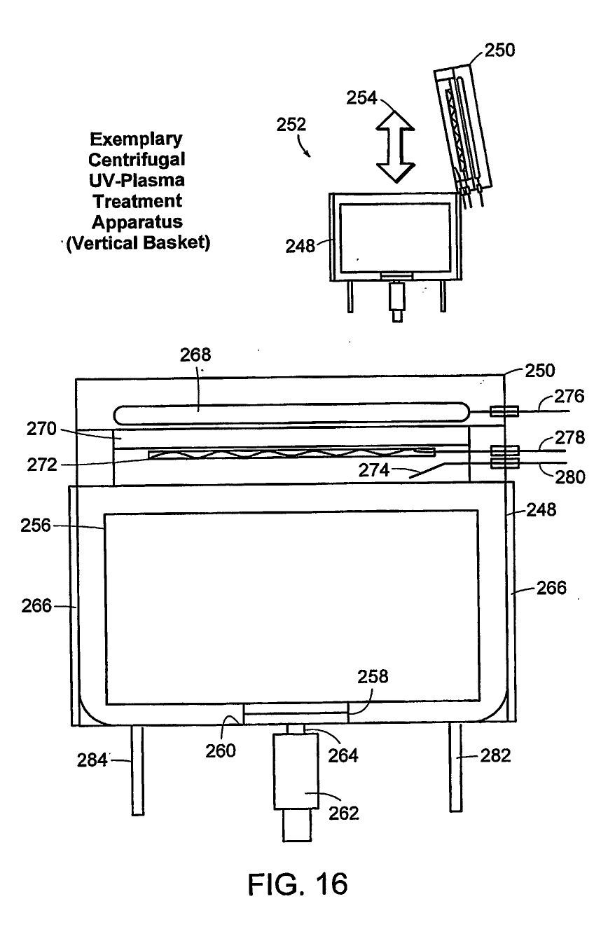

FIG. 16 gives an exemplary vertical basket UV-Plasma centrifuge treatment apparatus for use with the present invention. The exemplary apparatus comprises a pressure vessel (248) with a hinged pressure closure (250). The exemplary pressure closure (250) opens from and closes with or seals the exemplary vessel (248) as illustrated in sub-figure (252), with substrates (not shown) loaded into and out of the exemplary pressure vessel as shown by the arrow (254). The exemplary vessel (248) also contains a rotatable centrifuge drum (256), which is affixed to a suitable rotatable bearing assembly (258), which is fixed to the interior base (260). A magnetic drive assembly (262) is affixed to the outside of the pressure vessel, extends through a threaded port (264) and into the interior of the pressure vessel (248), forming a pressure seal therein. The exemplary drive (262) affixes to the bearing assembly (258). Thus, as shown, rotation of the magnetic drive assembly (262) is translated to the centrifuge drum (256). The magnetic drive assembly (262) may rotate the centrifuge drum (256) in a clockwise or counterclockwise rotation and at speeds of between 5 rpm to 1000 rpm. The exemplary pressure vessel (248) may contain heater bands (266) mounted to the exterior portions to provide reaction heat to the interior of the pressure vessel (248).

The exemplary closure (250) may be integrated with a xenon UV light source (268), which is used herein to transmit UV-VIS light into the interior of the pressure vessel (248) using a sealed quartz window (270). Below the window (270) and within the interior of the closure (250), a dielectric plasma discharge electrode (272) is positioned, which is used as an internal plasma energy source in the present invention. A PCA injection pipe (274) is also positioned within the interior of the closure (250), which is used to inject PCA into the treatment vessel (248). A pulsed power source (not shown) is connected to the xenon lamp electrode (276), which feeds through the closure (250) and connects to the xenon bulb (268). A plasma power supply (not shown) is connected to a plasma source electrode (278), which feeds through the closure (250) and connects to the exemplary plasma source (272). A source of PCA, for example FIG. 7 (84), is connected to a PCA injection inlet pipe (280). Finally, the exemplary pressure vessel (248) contains a pressure filling pipe (282) is located in the lower hemisphere of the pressure vessel to allow for the introduction of gases, dense fluids, and other treatment agents into the interior. A drain/vacuum port and connection pipe (284) is located in the lower hemisphere of the pressure vessel to allow for the removal of gases, dense fluids, and treatment by-products from the interior using a suitable vacuum or drain pump (both not shown).

Having described the basic components of the exemplary treatment system, the following is the general mechanical operation of said device. Substrates (not shown) are loaded into the centrifuge drum (256), which may include a suitable basket or fixture (both not shown). Following this, the closure (250) is closed and forms a pressure seal with the pressure vessel (248). The substrates may now be rotated in a bidirectional orientation and at various rotation velocities to impart the necessary centrifugal cleaning and sterilization forces necessary for the treatment process. An internal negative pressure (vacuum) may be created in said device by removing the interior atmosphere through drain/vacuum pipe (284), using a suitable vacuum pump (not shown). A pressure pump (not shown) may be used to pressurize the interior of the pressure vessel (248) through said fill pipe (282). Isolation valves (not shown), located on both said fill pipe (282) and vacuum/drain pipe (284), may be used to maintain the interior pressure conditions once achieved. Said external heaters (266) may be turned on and off to provide a desired operational temperature. Once the interior operating pressure and temperature is adjusted to a desired levels, or during the process of adjusting said pressure and temperature, the pulsed xenon light source (268) may be energized by turning on and off the light power source (not shown) and the plasma source may be ignited by turning on and off the plasma power supply (not shown). Using a suitable computer control means, the centrifuge, UV light source, plasma light source, PCA injection, pressurization means, and de-pressurization means can be programmed to work in any preset combination and sequence to enable the use of various treatment processes, methods and chemistries taught herein. This control system may also utilize pressure transducers, thermocouples and other physical monitoring device means to provide necessary pressure, temperature and other system operational data in real time.

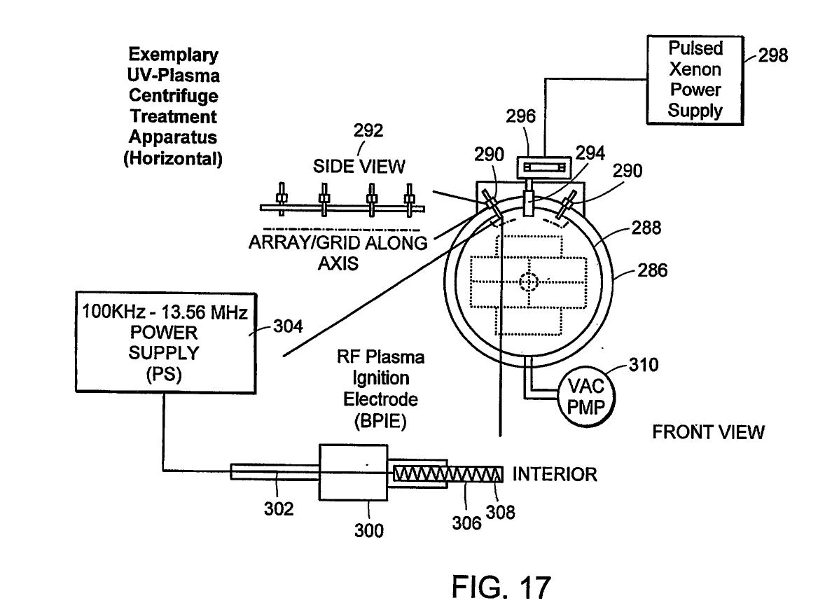

FIG. 17 gives an alternative and exemplary horizontal UV-Plasma centrifuge apparatus for use with the present invention. Referring to FIG. 17, an alternative UV-Plasma centrifuge design contains a horizontal treatment pressure vessel (286) and rotatable centrifuge drum (288). The upper and internal hemisphere of the exemplary apparatus contains an internal plasma source electrode (290) in the form of an array (292). A quartz light port (294) is positioned between the plasma electrode array (292) as shown. A xenon light source is affixed to the quartz light port (296), which is connected to a xenon light power supply (298). An exemplary plasma ignition electrode may be constructed and used as follows. A threaded conax electrode (300) (available from Conax Buffalo, Buffalo, N.Y.) containing a Teflon-insulated metal electrode (302) is connected to a high frequency power supply (304). A tubular alumina sheath (306) placed over the interior portion of said solid electrode (302) and having a stainless steel spring extender electrode portion (308). With the ignition electrode assembly inserted through and into the interior the exemplary pressure vessel (286) as shown in (290) and following creation of a negative pressure therein using a suitable vacuum pump (310), a dielectric barrier discharge is created by turning on and off the exemplary plasma power supply (304). This produces weakly ionized gas plasma within the interior of the pressure vessel, which for carbon dioxide atmospheres appears as a glowing blue hue. The general operation of this exemplary UV-Plasma centrifuge apparatus is similar to the apparatus and description given in FIG. 16.

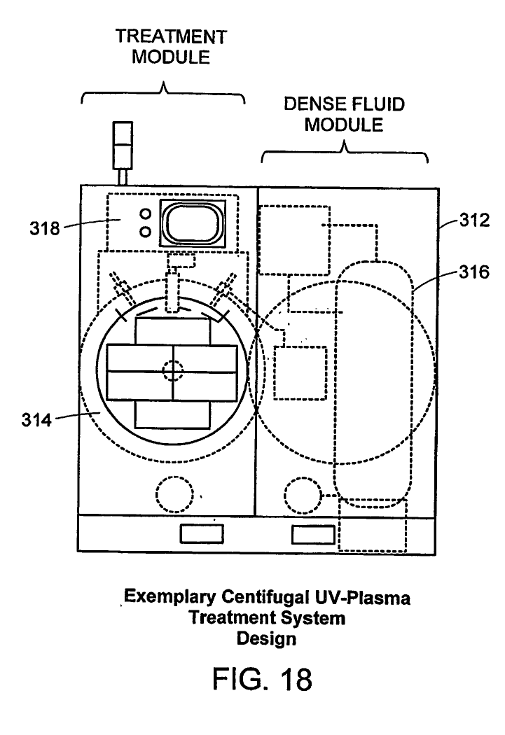

FIG. 18 gives a conceptualized commercial treatment system utilizing the exemplary horizontal UV-Plasma centrifuge described in FIG. 17. Referring to FIG. 18, the exemplary treatment system comprises a housing (312) containing the exemplary UV-Plasma centrifuge treatment system (314) of FIG. 17, a fluids management system (316), and a computer control system and operator interface (318).

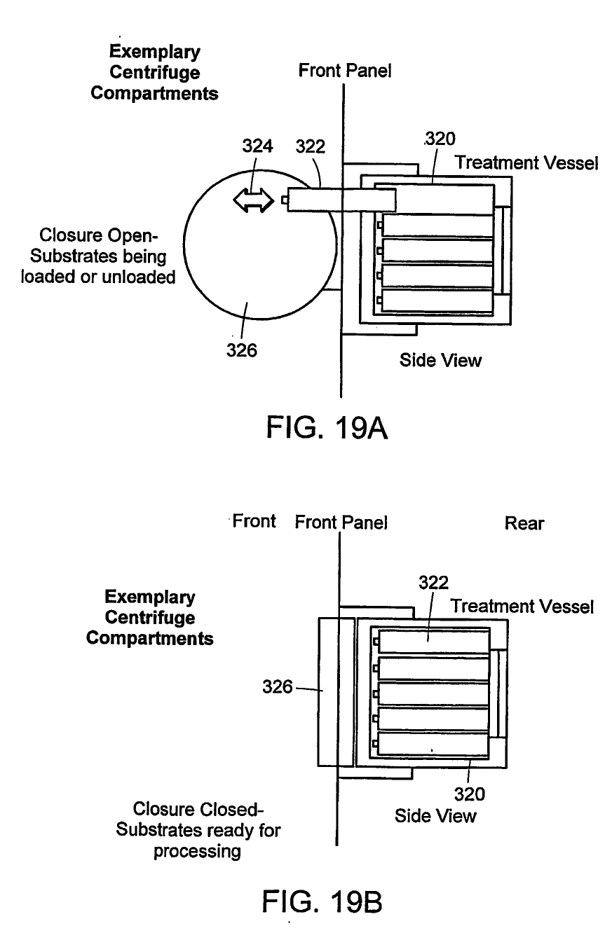

FIG. 19a and FIG. 19b show an exemplary centrifuge compartment design. Referring to FIG. 19a, the exemplary centrifuge drum (320) may be compartmentalized to include drawers (322), which can be made to slide in and out (324) of the centrifuge (320). Such as configuration allows for the treatment of mixed batches of substrates. Referring to FIG. 19b, the exemplary compartment (322) has been inserted into the centrifuge (320) with the closure (326) in the closed position.

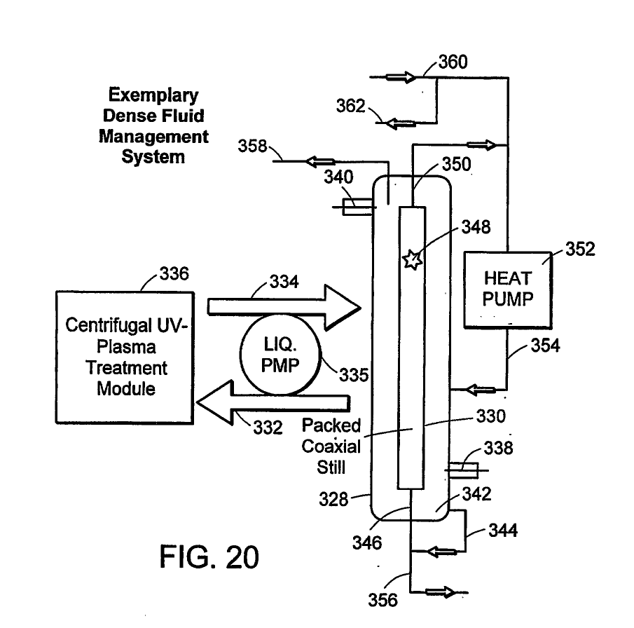

FIG. 20 gives an exemplary dense fluids management system for use with the exemplary treatment centrifuge apparatuses taught herein. Referring to FIG. 20, the exemplary dense fluid management system comprises a dense fluid holding tank (328) containing a centrally disposed dense fluid distillation tank (330). The dense fluid holding tank (328) communicates dense fluid to (332) and from (334) exemplary centrifuge treatment apparatuses (336) such as taught in FIG. 16 herein using a suitable liquid transfer pump (335). Dense fluids such as liquid carbon dioxide are typically held in the exemplary holding tank (328) under a constant pressure of between 850 psi and 1200 psi and a temperature of between 70 F and 85 F. A low level sensor (338) and a high level sensor (340) connected at the lower and upper hemispheres, respectively, of the holding tank (328) are used to maintain a proper quantity of recycled dense fluid for treatment operations. Treatment fluid is recycled continuously within the exemplary apparatus as follows. Dense fluid containing entrained or dissolved contaminants (342) is withdrawn from the holding tank (328) via an outlet pipe (344) and into the distillation tank (330) via an inlet pipe (346). Contaminated dense fluid (348) contained within the distillation tank (330) is evaporated and passed through a distillation pipe (350) and into a heat exchanger (352) which condenses the recycled dense fluid and returns the recycled product to the dense fluid storage tank (328) via a return pipe (354). This process operates continuously while the system is in use, with heat supplied to the holding tank (328) using a suitable heat source to maintain the distillation process. Periodically, the distillation tank (330) is drained to remove contaminant build-up through a drain line (356). The exemplary recycling system includes a vapor vent pipe (358) as well as a makeup carbon dioxide vapor inlet pipe (360) to add additional carbon dioxide to balance losses due to vapor use for plasma treatment and PCA production operations as well as losses attributed to contaminant blow-down operations described above.

Moreover, clean carbon dioxide vapor may be piped (362) directly to adjunct processes described herein such as for production of PCA and plasmas.

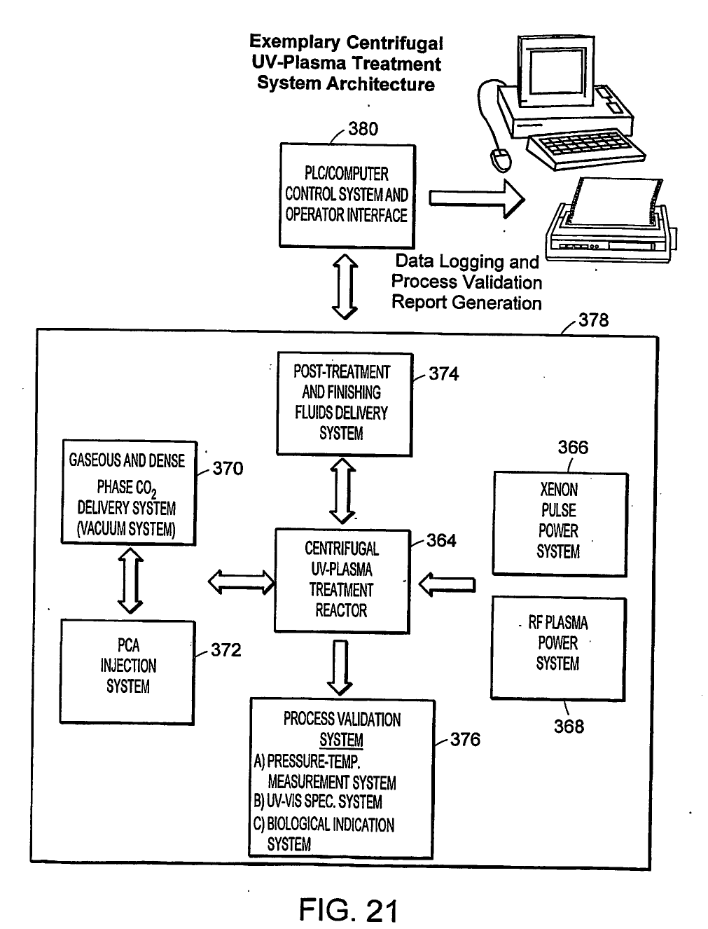

Having described various exemplary apparatuses for performing centrifugal UV-Plasma treatment processes and methods herein, FIG. 21 gives a summary of the exemplary architecture for a complete UV-Plasma centrifugal treatment system. Referring to FIG. 21, the central component comprises a UV-Plasma centrifuge reactor (364) which is integrated with a xenon light power source (366), plasma power source (368), and a dense fluid management system (370), which itself may contain a PCA generator and delivery sub-system (372). Moreover, an optional post-treatment fluid system (374) may be included with the system. Finally, a process validation sub-system (376) comprising pressure measurement sensors, temperature measurement sensors, and other process validation devices is incorporated into the system. The above-described systems comprise a complete UV-Plasma centrifugal treatment system (378), which may be integrated with a computer control system and software (380). The exemplary computer control system and software (380) may be integrated with a printer to provide printed process validation reports following treatment operations.

Certain preferred treatment methods of the invention include methods for cleaning, disinfecting, sterilizing, functionalizing, or coating a substrate surface. These methods, although not exhaustive, teach various clean-sterilization and clean-sterilization-functionalization combinations using the unique chemistries, processes, methods, and apparatuses taught herein.

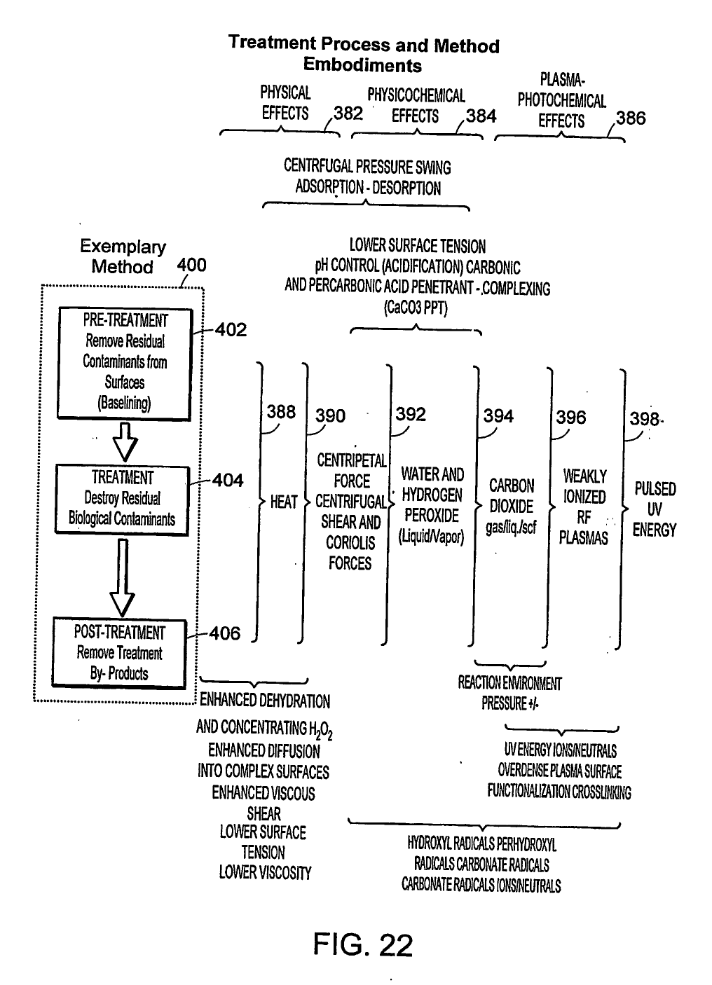

FIG. 22 gives a summary of treatment process and method embodiments of the present invention and discussed in detail herein. Referring to FIG. 22, these embodiments comprise a combination of physical process combinations (382), physicochemical process combinations (384), and plasma-photochemical process combinations (386). Numerous processes and methods may be developed and used comprising a combination of heat (388), centrifugal and Coriolis energies (390), hydrogen peroxide chemistry (392), carbon dioxide chemistry (394), plasmas (396), and pulsed UV photons (398). Numerous treatment benefits and enhancements previously discussed herein in detail are summarized in FIG. 22. Thus, an exemplary method (400) may comprise numerous pre-treatments (402), treatments (404), and post-treatments (406) utilizing the aforementioned treatment process combinations.

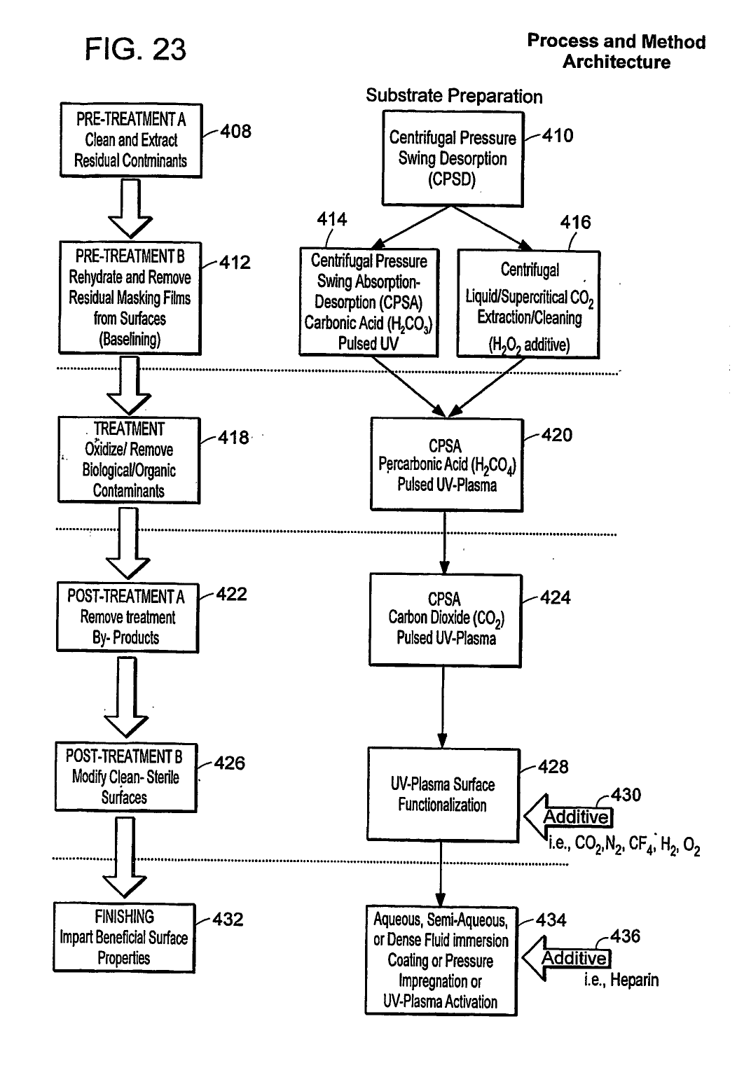

FIG. 23 gives a more detailed description of various method and process architectures that may be developed using the present invention. Referring to FIG. 23, an exemplary method and process may comprise different substrate pre-treatments. For example, pre-treatments may comprise a pre-clean or extraction step (408), for example comprising a vacuum extraction process (410). Pre-treatments may include a re-hydration or cleaning step (412), for example comprising a CPSA extraction process (414) or a dense fluid extraction/cleaning process (416). The exemplary sterilization treatment (418) described herein comprises the CPSA process (420) using centrifugal, UV-Plasma, and PCA chemistries described herein. Post-treatments may include an extraction step (422), comprising UV-Plasma and CPSA processes (424) described herein. Post-treatments may include a surface modification step (426), comprising a UV-Plasma surface treatment process (428) using various plasma surface modification agents (430). Finally, a substrate surface finishing step (432) may be implemented, for example comprising a dense fluid impregnation or coating process (434) utilizing an coating additive (436) such as Heparin.

It also should be noted that many commercial disinfectant-cleaning agents, some of which have been described herein, can optionally be used with substrate pre-treatment agents in the present invention. These may include general-purpose liquid cleaning agents, which serve as a gross surface pretreatment step prior to precision treatment and post-treatment processes taught herein.

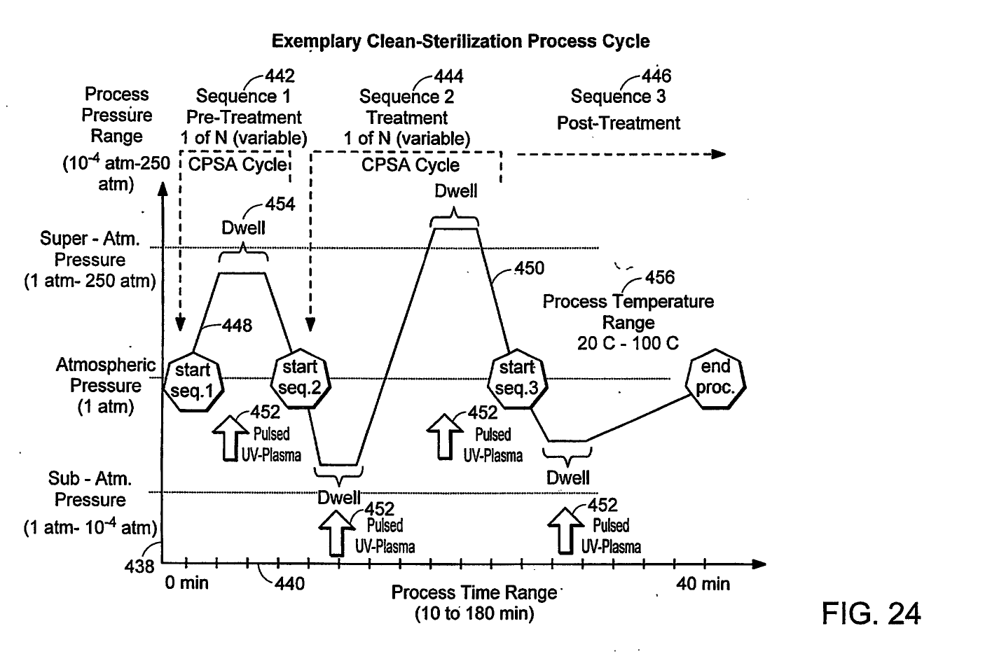

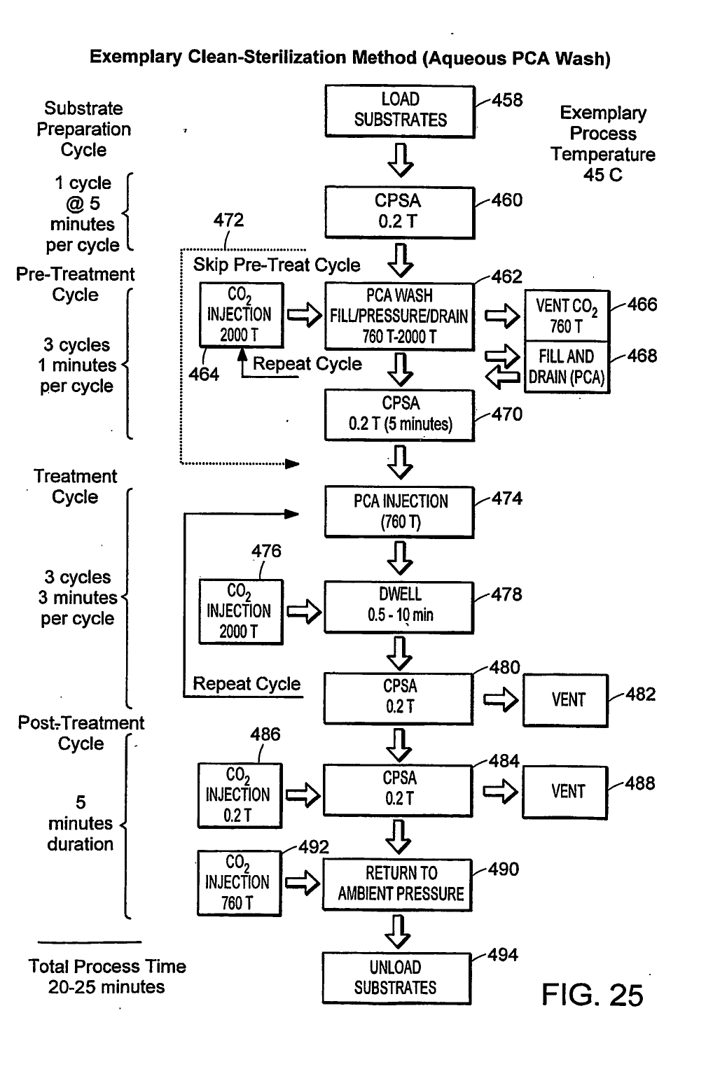

Now referring to FIG. 24, a preferred application of the cleaning and sterilization methods is provided. The process described in FIG. 24 is generally referred to herein as a “clean-sterilization” process. A typical process cycle comprises a centrifugal pressure swing adsorption-desorption cycle (CPSA), which always starts at atmospheric pressure conditions (substrates loaded into chamber), which may begin with a pressure swing from atmospheric pressure to super-atmospheric or sub-atmospheric pressure conditions, and always ends with the substrate at atmospheric pressure conditions. Each CPSA cycle pressure is represented by the vertical axis (438) and may range from 1×10⁻⁴ atm to 250 atm or more. The exemplary process cycle also comprises a time scale, which may run from 0 minutes to 180 minutes or more. This is represented by the horizontal axis (440). One or more CPSA cycles may be used throughout the entire treatment process, and within each process step, in this case a pre-treatment step (442), a treatment step (444), and a post-treatment step (446). Within each CPSA cycle, the pressurization rate can be controlled and varied, represented by the slope of the pressurization line (448), and the depressurization rate can be controlled and varied, represented by the slope of the depressurization line (450). During each process step, and at various points along a process step, UV-Plasma energy, PCA and other additives described herein are added as required, represented by the black arrows (452). Finally, a CPSA cycle may have a dwell period (454) or a soaking period, wherein upon reaching either a maximum pressure or minimum pressure the pressure is held for a pre-determined period of time. Dwell periods can last from a few seconds to 60 minutes or more. Finally, generally the entire treatment process is performed using optimized process step temperatures (456) that may range from approximately 20 C to as high as 100 C.

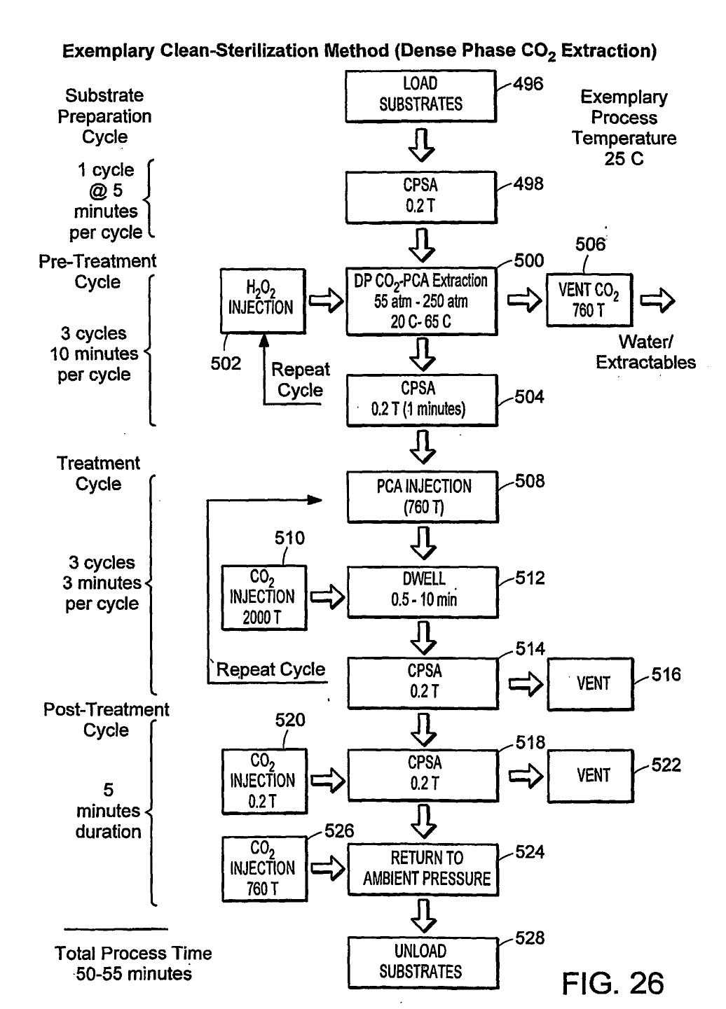

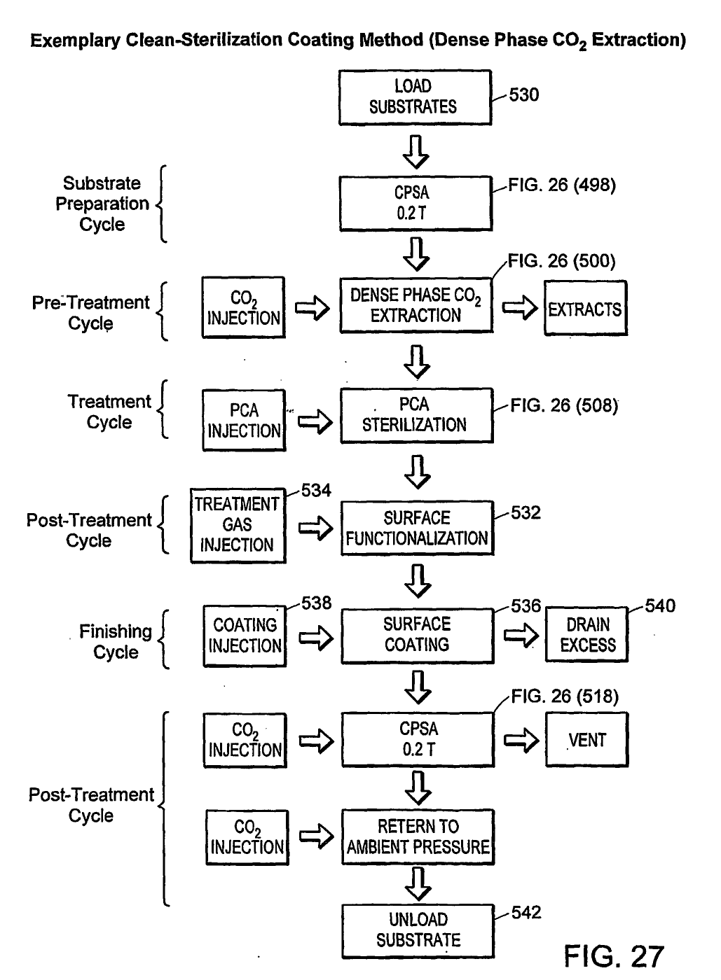

Having described the general characteristics of a process cycle using the various embodiments described herein, FIG. 25, FIG. 26, and FIG. 27 give exemplary clean-sterilization methods using the apparatuses, chemistries, and processes herein.

FIG. 25 depicts a preferred method using an aqueous or semi-aqueous pre-cleaning step and followed by a sterilization treatment step. Referring to FIG. 25, the exemplary method comprises first loading a substrate into the exemplary centrifugal UV-Plasma treatment apparatus (458), for example as described in FIG. 16 herein, and sealing the closure (FIG. 16 (250)). At this point, the exemplary centrifuge drum described in FIG. 16 is rotated bi-directionally with speeds of between 5 rpm and 1000 rpm for a period of between 30 seconds and several minutes in a clockwise direction, stopped, and reversed for a period of between 30 seconds and several minutes in a counterclockwise direction. The exemplary centrifuge process continues throughout the entire treatment method. Changes to the centrifugal process may be made as required to optimize various steps within the treatment method. The first step of the exemplary method comprises a surface preparation cycle (460), which involves a single CPSA cycle at a pressure of 0.2 T and a temperature of 45 C for 5 minutes. During this step, gases and other volatiles are being removed from spaces and pores of the substrate and contaminants contained thereon in preparation for the following CPSA pre-treatment cycle. This greatly enhances the penetration of pre-treatment agents into interstitial voids created by the CPSA vacuum preparation cycle (460).

Following the substrate preparation cycle (460), a pretreatment step (462) is performed. The pre-treatment step (462) in this example involves the use of a pre-wash agent consisting of deionized water, hydrogen peroxide, surface-active agents, and corrosion prevention agents. This mixture is injected into the exemplary centrifugal washing system whereupon carbon dioxide gas is injected to a pressure of 2000 T, forming the percarbonic acid washing agent. During the centrifugal pre-treatment step (462), carbon dioxide gas is injected (464) and released (466) one or more times to create a pressure swing cycle similar to the one shown in FIG. 24 (442) improves cleaning action by both mechanical and chemical modification of the PCA wash agent. Moreover, the exemplary pulsed UV light source may be turned on at this point to provide ultraviolet radiation in the pre-wash agent. This produces additional cleaning agents in the form of hydroxyl and perhydroxyl radicals, which enhance the cleaning and disinfection action of the PCA pre-wash agent. This may occur for a total of 3 CPSA cycles with a CPSA cycle lasting 1 minute each. Finally, the contaminated pre-wash agent is removed (468) from the treatment chamber, filtered, and disposed of in an appropriate manner. A vacuum pump is turned on the pre-treated substrates are dried using CPSA (470) under vacuum and optionally aided by the pulsed UV radiation (Vacuum-UV drying). This process continues until the pressure within the treatment chamber reaches 0.2 T.

As shown in FIG. 25, the pre-treatment step is an optional step in the exemplary method and may be skipped (472) entirely if only a sterilization process is desired. Such a pre-treatment step may be required if the substrates contain gross amounts of biological, chemical, or particulate contaminants which would degrade the performance of treatment or post-treatment processes described herein.

In certain preferred sterilization methods of the invention, the sterilization treatment is conducted as described in FIG. 24 in conjunction with at least one of a pre-treatment step or a CPSA vacuum drying step. Similar to the treatment process step described in FIG. 24 (444), the sterilization treatment step consists of injecting a mixture of PCA (474) as described herein under a pressure of 0.2 T, which has been provided under the substrate preparation step (460) or following the optional CPSA drying step (470). This causes the pressure within the treatment reactor to rise significantly up to approximately 760 T. At this point, carbon dioxide gas is injected (476) into the treatment chamber to achieve a CPSA pressure of approximately 2000 T. This step drives the mixture of PCA into pores and spaces of the substrate, increasing acidity and lowering the surface tension of the PCA complex. Following this, a dwell or soak period (478) of between 30 seconds and 10 minutes is maintained at 2000 T. Following the dwell period (478), the treatment chamber is depressurized (480) at a pre-determined rate to approximately 0.2 T and PCA treatment by-products are vented (482) from the treatment chamber. This step may be repeated one or more times, in this example 3 cycles are performed and each cycle comprises approximately 3 minutes. During the sterilization treatment step, pulsed UV-Plasma is preferably applied during the entire cycle.

Following the sterilization treatment cycle, a post-treatment step is typically performed to remove residual treatment by-products such as hydrogen peroxide and water vapor from the substrates and treatment chamber. Similar to the post-treatment process step described in FIG. 24 (446), the post-treatment step (484) consists of back-flowing carbon dioxide gas (486) with a UV-Plasma at a pressure of approximately 0.2 T for a dwell period of approximately 5 minutes. Residual treatment products are removed from the substrate and treatment chamber through a suitable vent (488). Finally, the pressure within the treatment chamber is returned to ambient pressure (490) by allowing carbon dioxide gas (492) to continue to flow into the chamber.

At this point, the centrifuge and UV-Plasma sources are turned off, completing the post-treatment step. The exemplary closure described in FIG. 16 (250) is opened and clean-sterile substrates are removed (494) from the treatment chamber. Certain particularly preferred treatment methods of the invention as recited herein have a total process cycle time of approximately 20 to 25 minutes.

FIG. 26 provides an exemplary treatment method of the invention which uses a dense fluid extraction step followed by a sterilization treatment step. Referring to FIG. 26, the exemplary method comprises first loading a substrate into the exemplary centrifugal UV-Plasma treatment apparatus (496), for example as described in FIG. 16 herein, and sealing the closure (FIG. 16 (250)). At this point, the exemplary centrifuge drum described in FIG. 16 is rotated bi-directionally with speeds of between 5 rpm and 1000 rpm for a period of between 30 seconds and several minutes in a clockwise direction, stopped, and reversed for a period of between 30 seconds and several minutes in a counterclockwise direction. The exemplary centrifuge process continues throughout the entire treatment method. Changes to the centrifugal process may be made as required to optimize various steps within the treatment method.

The first step of the exemplary method depicted in FIG. 26 comprises a surface preparation cycle (498), which involves a single CPSA cycle at a pressure of 0.2 T and a temperature of 45 C for 5 minutes. During this step, gases and other volatiles are being removed from spaces and pores of the substrate and contaminants contained thereon in preparation for the following CPSA pre-treatment cycle. This greatly enhances the penetration of pre-treatment agents into interstitial voids created by the CPSA vacuum preparation cycle (498).

Following the substrate preparation cycle (498), a pre-treatment step (500) is performed. The pre-treatment step (500) in this example involves the use of a dense phase carbon dioxide pre-cleaning agent consisting of liquid carbon dioxide or supercritical carbon dioxide, and may contain one or more additives, at a pressure of between 55 atm and 250 atm and a temperature of between 20 C and 80 C. This dense fluid cleaning-extraction may also be injected with hydrogen peroxide (502) to form a dense fluid PCA complex therein. As shown, several cycles may be performed to remove residual contaminants from substrate surfaces in preparation for the following treatment cycle. In this example, a UV-Plasma is used only during a CPSA vacuum extraction cycle (504) to assist with pre-cleaning and drying the substrate. Following this pre-treatment, residual gases are vented (506) and contaminants such as oils, plasticizers, and particles are captured and disposed of in a proper manner.

During the centrifugal dense phase pre-treatment step (500) depicted in FIG. 26, a pressure swing cycle similar to the one shown in FIG. 24 (442) improves cleaning action by both mechanical and chemical modification of the PCA complex. Moreover, the exemplary pulsed plasma source may be turned on at this point to provide ultraviolet radiation and carbon dioxide radicals. This produces additional cleaning agents in the form of atomic oxygen, hydroxyl radicals, and perhydroxyl radicals, which enhance the cleaning and disinfection action of the dense fluid PCA pre-wash agent. This may occur for a total of 3 CPSA cycles with a CPSA cycle lasting 10 minutes each. Finally, the contaminated pre-wash agent is removed (506) from the treatment chamber, filtered, and recycled using the exemplary dense fluid management system described in FIG. 20. A vacuum pump is turned on the pre-treated substrates are dried using CPSA (504) under vacuum and optionally aided by the pulsed-UV-Plasma radiation (Vacuum-UV drying). This process continues until the pressure within the treatment chamber reaches 0.2 T.

Following the pre-treatment step (500) and CPSA vacuum drying step (504), a sterilization treatment step is performed. Similar to the treatment process step described in FIG. 24 (444), the sterilization treatment step of FIG. 26 consists of injecting a mixture of PCA (508) as described herein under a pressure of 0.2 T, which has been provided by the CPSA drying step (504). This causes the pressure within the treatment reactor to rise significantly up to approximately 760 T. At this point, carbon dioxide gas is injected (510) into the treatment chamber to achieve a CPSA pressure of approximately 2000 T. This step drives the mixture of PCA into pores and spaces of the substrate, increasing acidity and lowering the surface tension of the PCA complex. Following this, a dwell or soak period (512) of between 30 seconds and 10 minutes is maintained at 2000 T. Following the dwell period (512), the treatment chamber is depressurized (514) at a pre-determined rate to approximately 0.2 T and PCA treatment by-products are vented (516) from the treatment chamber. This step may be repeated one or more times, in this example 3 cycles are performed and each cycle comprises approximately 3 minutes. During the sterilization treatment step, pulsed UV-Plasma is applied during the entire cycle.

Following the sterilization treatment cycle, a post-treatment step is performed to remove residual treatment by-products such as hydrogen peroxide and water vapor from the substrates and treatment chamber. Similar to the post-treatment process step described in FIG. 24 (446), the post-treatment step (518) consists of back-flowing carbon dioxide gas (520) with a UV-Plasma at a pressure of approximately 0.2 T for a dwell period of approximately 5 minutes. Residual treatment products are removed from the substrate and treatment chamber through a suitable vent (522). Finally, the pressure within the treatment chamber is returned to ambient pressure (524) by allowing carbon dioxide gas (526) to continue to flow into the chamber.

At this point, the centrifuge and UV-Plasma sources are turned off, completing the post-treatment step. The treatment chamber described in FIG. 16 (250) is opened and clean-sterile substrates are removed (528) from the treatment chamber. The exemplary treatment method thus described comprises total process cycle time of approximately 50 to 55 minutes.

FIG. 27 provides a preferred method of the invention which uses a dense fluid extraction step followed by a sterilization treatment step, and surface finishing steps comprising surface modification and coating steps. Referring to FIG. 27, the exemplary method comprises first loading a substrate into the exemplary centrifugal UV-Plasma treatment apparatus (530), for example as described in FIG. 16 herein, and sealing the closure (FIG. 16 (250)). At this point, the exemplary centrifuge drum described in FIG. 16 is rotated bi-directionally with speeds of between 5 rpm and 1000 rpm for a period of between 30 seconds and several minutes in a clockwise direction, stopped, and reversed for a period of between 30 seconds and several minutes in a counterclockwise direction. The exemplary centrifuge process continues throughout the entire treatment method. Changes to the centrifugal process may be made as required to optimize various steps within the treatment method.

The first step of the exemplary method depicted in FIG. 27 comprises the substrate preparation step described in FIG. 26 (498). The second step comprises the substrate pre-treatment step described in FIG. 26 (500). The third step comprises the substrate sterilization step described in FIG. 26 (508).

Following the substrate preparation, pre-treatment, and sterilization steps, the clean-sterile substrate is subjected to a UV-Plasma post-treatment step to activate substrate surfaces such as providing a high surface free energy surface. In the surface functionalization step (532), a treatment gas (534) comprising compounds such as carbon dioxide, hydrogen peroxide, nitrogen, carbon tetrafluoride, alcohols, amines, and other fluids which, when subjected to either UV or plasma energy, will impart a beneficial surface functionality such as carboxyl, amine, nitrogen, fluorine or other active chemical groups. These properties enhance the physicochemical attachment of coating agents under the following step.

Following the substrate post-treatment process, the treatment process may optionally comprise a step of coating or impregnating the substrate surface. Thus a coating or impregnate (536) can be applied to the surface of the substrate. This may be performed as a CPSA vapor deposition process, CPSA liquid immersion process, or CPSA dense fluid pressure impregnation process. Coatings (538) may comprise lubricants, anti-coagulants, anti-inflammatory agents, and other beneficial agents which once attached to the clean-sterile substrate provide beneficial characteristics such as biocompatibility, increased lubricity, and generally an improved performance of the treated substrate. Excess coating agents are removed (540) under vacuum from the treatment chamber. UV and/or plasma may be used during the coating process to form coating precursors or may be used following coating to cross link and permanently bond the coating agent to the treated surface.

Finally, a post-treatment process is performed as described in FIG. 26 (518-) to remove residual coating agents and to return the substrate to ambient pressure conditions. At this point, the centrifuge and UV-Plasma sources are turned off, completing the post-treatment step. The exemplary closure described in FIG. 16 (250) is opened and clean-sterile substrates are removed (542) from the treatment chamber.

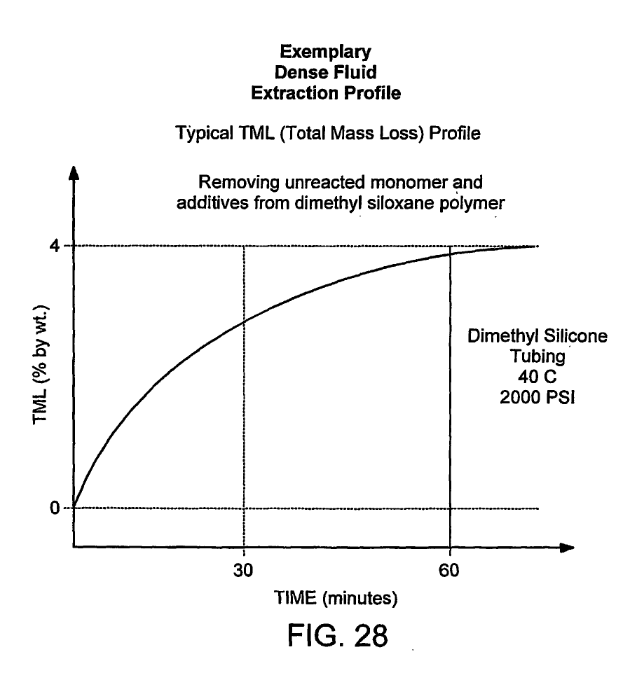

FIG. 28 gives an exemplary dense fluid extraction profile for polymeric substrates pre-treated using supercritical carbon dioxide, for example as described in FIG. 26 (500). Referring to FIG. 28, the typical extraction profile for polydimethylsiloxane, a common medical device material of construction, exhibits a mass loss of between 0% to 4%, and more during the extraction cycle over a 60minute period. Although it is not necessary to remove all of the extractable contaminants in every case, a 10-minute extraction cycle will remove surface and subsurface contaminants to degree, which is beneficial for most treatment and finishing processes described herein. An exception to this is where substrate materials are to be used in high vacuum systems.

In yet another aspect the invention provides a method and apparatus for monitoring in real time the progress of the substrate treatment methods provided herein. Thus, for example, certain preferred monitoring methods provided by the invention include the steps of:
providing a test substrate having at least one chemical or biological contaminant deposited thereon;
measuring the UV-Vis spectrum of the test substrate prior to cleaning or sterilizing;
contacting the test substrate with the fluid comprising percarbonic acid under conditions conducive to cleaning or sterilizing the substrate;
measuring the UV-Vis spectrum of the test substrate periodically during and after contacting the test substrate with the fluid; and
comparing the periodic UV-Vis spectra against the pre-cleaning or pre-sterilizing UV-Vis spectrum to monitor the cleaning or sterilization process.

Certain preferred monitoring apparatus and monitoring methods of the invention comprises a in-situ or ex-situ UV-VIS spectrophotometric process and apparatus are taught for performing UV-Plasma radiation and reaction diagnostics as well as performing chemical cleaning and sterilization process validation testing using the unique chemistries, processes, methods, and apparatuses taught herein.

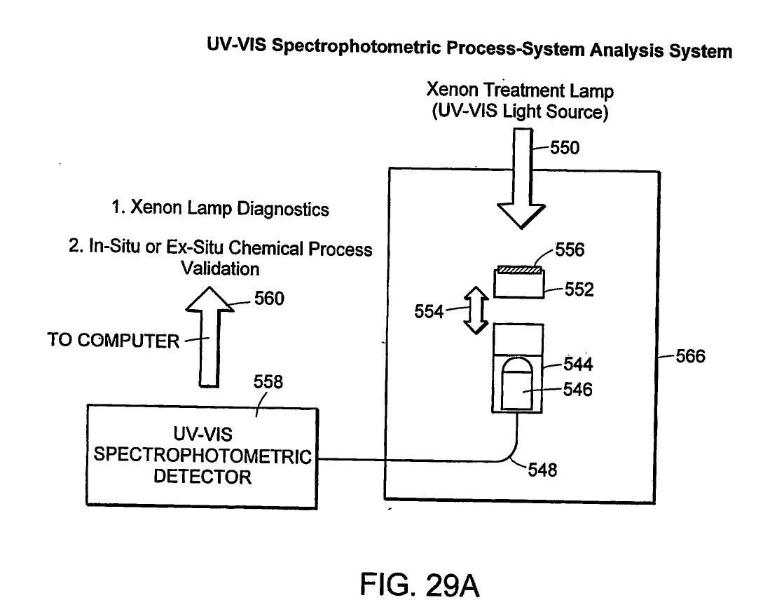

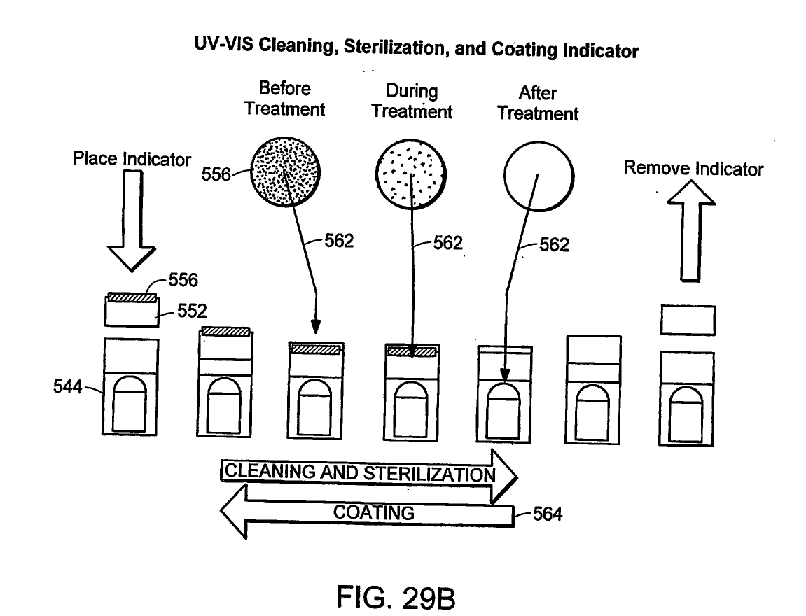

Now referring to FIG. 29, a preferred UV-VIS spectrophotometric apparatus is described that is suitable for monitoring the treatment processes provided herein. The xenon light source used for UV-Plasma treatment processes herein is also used as a light source for detecting the performance of the various treatment processes herein. Referring to FIG. 29a, a fiber optic light collimating apparatus (544), comprising a fiber optic collimator (546) connected to a fiber optic cable (548), collects and transmits UV light (550) which is derived from the same source used for treatment operations herein. Placed between the light collecting apparatus (544) and UV light source (550) is a quartz process indicator lens (552), which is inserted and de-inserted (554) into the collimating apparatus as shown. The topside surface (556) may contain any variety of chemical and physical coatings including chemical and biological agents representing various challenge soils and which absorb within the UV-VIS light range provided by the exemplary xenon light source described in FIG. 10 herein. For example bovine serum, oils, particles, resist residues, and other simulated contaminants may be coated onto the lens and used as simulation coupons. Using the exemplary testing apparatus as shown, UV-VIS light passes through the indicator (552), into the collimator (546), through the fiber optical cable (548) and into a UV-VIS spectrophotometer with detector (558). The UV-VIS processes the incoming light and produces a signal in absorbance units for a range from 200 nm to 800 nm or more. This signal may be sent to a computer (560) for process monitoring activities as described in FIG. 21 herein.

The present embodiment provides at least two advantages over known monitoring techniques (1) the ability to monitor and validate in real-time the physicochemical processes within the treatment system and (2) the ability to diagnose xenon light output to prevent the use of a degraded light source or to determine if a light source exists.

Referring to FIG. 29b, a simulated contaminant (556) located on the indicator lens (552) will absorb UV-VIS light at different stages (562) of the treatment process as it is being removed from the surface of the lens. This provides a means for determining the effectiveness of a particular treatment process during development and more importantly provides a means for monitoring in real-time the cleaning and sterilization process herein. Moreover, as shown in FIG. 29b, the same technique may be applied to surface coating (564) processes described herein. In a first step during cleaning, sterilization and functionalization processes herein, a computer (not shown) processes incoming UV-VIS light signal and determines that the substrate is clean (i.e., UV-VIS light transparent). In real-time, the same computer analyzes the UV-VIS light signal during coating processes to determine the deposition rate and thickness of UV-VIS thin film coatings.

Indicators may be developed as prepackaged “standard cleaning test indicators” for any variety of substrate treatment processes and methods developed using the present invention. Another advantage of the present embodiment is that the test apparatus as described herein may be used in-situ within the treatment reactor (566), or alternatively, test coupons (552) as described above may be processed and tested independently and tested using the same test apparatus ex-situ.

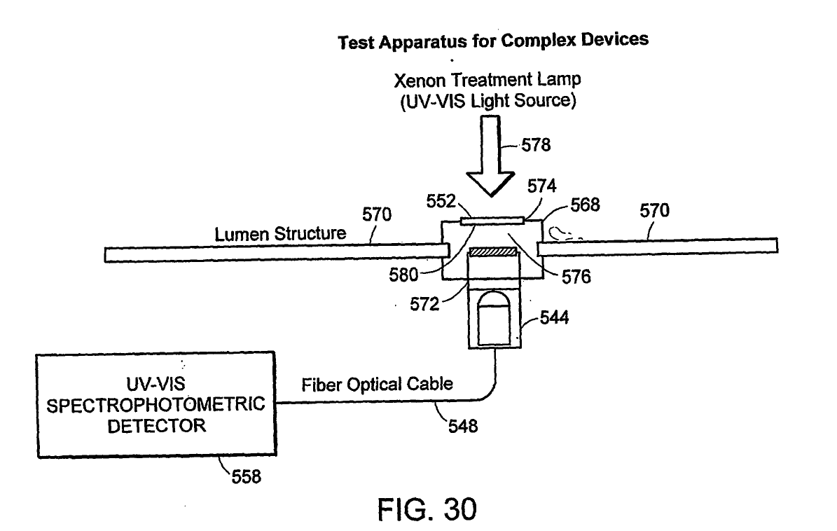

Now referring to FIG. 30, a preferred challenge test apparatus for use with the exemplary UV-VIS testing apparatus and method of FIG. 29. The challenge test apparatus comprise a body such as a tee (568), which is connected to simulated complex substrate features such as a lumen structure (570). The challenge test apparatus tee (568) contains a port (572) for connecting the collimator assembly described in FIG. 29 (544), which is connected to the fiber optical cable (548) and UV-VIS spectrophotometer (558). Finally the test body tee (568) contains a port (574) for the insertion and de-insertion of the soil test lens (552). In the present embodiment, the test lens (552) is inserted in an inverted orientation so that the challenge soil is presented to the interior (576) region of the complex test substrate. Thus UV-VIS light (578) is transmitted through the lens containing a contaminant on the interior surface (580) and into the collimating light collector (544).

Using the challenge test apparatus thus described allows for developing and parameterizing cleaning and sterilization processes and methods for substrate surfaces having complex geometries.

Having taught the exemplary treatment methods, processes, chemistries and apparatuses of the present invention, following are examples of use.

### EXAMPLES

### Example 1

### Sterilization

An efficacy test was performed using the percarbonic acid complex in a closed system to determine its effectiveness in inactivating (killing) spores used on various standard biological test indicators. In this test a biological challenge of 10⁶ B. Subtilis and B. Stearothermophilus spores was used.

Sporicidal screening tests were performed using a 1-liter closed reactor containing a vertical centrifuge basket and exemplary UV-Plasma energy sources similar to those described herein. Screening tests are performed generally in accordance with AOAC guidelines and methodology. Biocidal screening procedures involved the following materials and procedures:
Biological Indicators (BI):
   a. Black Silk Suture Loops (SSL) inoculated with Bacillus Subtilis ATCC 19659
   b. Porcelain Penicylinders (PP) inoculated with B. Subtilis ATCC 19659
   c. Biological Indicator for Gaseous Hydrogen Peroxide inoculated with Bacillus Stearothermophilus ATCC 12980
Screening Test Procedure: (AOAC Protocol)

BI samples a and b above were re-hydrated and subjected to a percarbonic acid treatment process for a period of 30 minutes. Following this, the samples are aseptically transferred into Fluid Thioglycolate Broth (FTB), incubated at 37° C. for 21 days, heat shocked at 80° C. using a heated water bath, and re-incubated for an additional 72 hours at 37° C.

BI samples c was subjected to the sterilization process conditions described herein. Following this, the samples are aseptically transferred into Tryptic Soy Broth (TSB), incubated at 55°-60° C. for 7 days.

All testing, regardless of specific process conditions, was performed with a relative process cycle time limitation of 45 minutes. However, it should be noted that test results indicate that this time constraint may be reduced considerably.

Efficacy of Percarbonic Acid Treatment: (positives/samples @ 30 minutes)

| | | | 72 Hour |
|---|---|---|---|
| BI Indicator | 7 days | 21 days | (Shock Test) |
| A. | 0/6 | 0/6 | 0/6 |
| B. | 0/3 | 0/3 | 0/3 |
| C. | 0/6 | n/a | n/a |

### Example 2

### Dimethylsilicone Drainage Tube

In this example, a dimethylsilicone drainage tube is extracted with 98% supercritical carbon dioxide-2% hydrogen peroxide PCA (v:v) extraction mixture to remove interstitial silicone monomers and other ionic contaminants. Pre-cleaning removes residual organic, inorganic, and ionic extractable contaminants to prepare the substrate surfaces for an effective follow-on UV-Plasma PCA sterilization step. Following pre-cleaning, the substrates are CPSA vacuum dried to remove residual pre-cleaning residues and then processed using a UV-Plasma CPSA PCA process described herein to remove or decompose residual surface contamination and bacteria. Following this treatment process, clean-sterile substrate surfaces are subjected to an additional UV-Plasma treatment sequence using carbon dioxide and nitrogen gas to produce a functionalized surface having a high surface free energy.

### Example 3

### Polyester Grafting Fabric

In this example, a polyester grafting fabric is extracted with 98% liquid carbon dioxide-2% hydrogen peroxide PCA (v:v) extraction mixture to remove interstitial silicone monomers and other ionic contaminants. Pre-cleaning removes residual organic, inorganic, and ionic extractable contaminants to prepare the substrate surfaces for an effective follow-on UV-Plasma PCA sterilization step. Following pre-cleaning, the substrates are CPSA vacuum dried to remove residual pre-cleaning residues and then processed using a UV-Plasma CPSA PCA process described herein to remove or decompose residual surface contamination and bacteria. Following this treatment process, clean-sterile substrate surfaces are subjected to an additional UV-Plasma surface treatment sequence using carbon dioxide and nitrogen gas to produce a functionalized surface having high surface free energy. This device is then pressure impregnated with a commercial anti-coagulant agent, UV-Plasma treated to cross link and bond said anti-coagulant agent to said substrate surfaces.

The invention has been described in detail with reference to preferred embodiments thereof. However, it will be appreciated that those skilled in the art, upon consideration of the disclosure, may make modifications and improvements within the spirit and scope of the invention.

All of the patents and publications cited herein are hereby incorporated by reference.

Those skilled in the art will recognize, or be able to ascertain using no more than routine experimentation, many equivalents to the specific embodiments of the invention described herein. Such equivalents are intended to be encompassed by the following claims.

1. A method of preparing percarbonic acid or a composition comprising same, the method comprising the step of contacting hydrogen peroxide and carbon dioxide in the presence of at least one of a plasma or UV radiation and under conditions conducive to formation of percarbonic acid.

2. The method of claims 1, wherein the hydrogen peroxide is an aqueous hydrogen peroxide solution.

3-4. (canceled)

5. The method of claim 1, wherein the hydrogen peroxide and carbon dioxide are contacted in the presence of a plasma.

6. The method of claim 1, wherein the hydrogen peroxide and carbon dioxide are contacted in the presence of UV radiation.

7. The method of claim 1, wherein the hydrogen peroxide and carbon dioxide are contacted in the presence of a plasma and UV radiation.

8. The method of claim 1, wherein the hydrogen peroxide and carbon dioxide are contacted at a temperature of between about 5 and 200° C. and a pressure of between 4 and 10 MPa.

9. The method of claim 2, wherein the aqueous solution of hydrogen peroxide is contacted with liquid or supercritical carbon dioxide under conditions conducive to formation of percarbonic acid.

10. The method of claim 9, wherein the aqueous hydrogen peroxide is contacted with supercritical carbon dioxide.

11. (canceled)

12. The method of claim 9, wherein the aqueous hydrogen peroxide is contacted with liquid carbon dioxide.

13. (canceled)

14. The method of claim 9, wherein the aqueous solution of hydrogen peroxide is contacted with liquid or supercritical carbon dioxide in a continuous flow extraction apparatus.

15-25. (canceled)

26. A method of cleaning a substrate, the method comprising the step of contacting a substrate with a fluid comprising percarbonic acid under conditions conducive to removing contaminants from the substrate.

27. The method of claim 26, wherein the contaminants are at least one of biological, organic, inorganic or particulate residues.

28. A method of at least one of disinfecting or sterilizing a substrate, the method comprising the step of contacting a substrate with a fluid comprising percarbonic acid under conditions conducive to disinfecting or sterilizing the substrate.

29. A method of cleaning and at least one of disinfecting or sterilizing a substrate, the method comprising the step of contacting a substrate with a fluid comprising percarbonic acid under conditions conducive to removing contaminants from the substrate and conducive to disinfecting or sterilizing the substrate.

30. (canceled)

31. The method of claim 29, wherein the contaminants are biological, organic, inorganic, or particulate residues.

32-33. (canceled)

34. The method of claim 29, wherein the fluid comprises liquid or supercritical carbon dioxide.

35. The method of claim 28, wherein the fluid and the substrate are contacted with a plasma.

36-38. (canceled)

39. The method of claim 35, wherein the plasma is an UV irradiated and weakly ionized plasma.

40. (canceled)

41. The method of claim 28, wherein the fluid and the substrate are irradiated with UV light during at least a portion of the contacting step.

42. The method of claim 41, wherein at least about 40% of the UV irradiation has a wave length of less than 300 nm.

43-44. (canceled)

45. The method of claim 41, wherein the UV irradiation is continuous or intermittent.

46-51. (canceled)

52. The method of claim 28, wherein the fluid further comprises at least one additive.

53. The method of claim 52, wherein the additive is selected from the group consisting of inert gases, ozone, nitrogen, noble gases, carbon monoxide, carbon tetrachloride, carbon tetrafluoride, hydrogen peroxide, and mixtures thereof.

54. The method of claim 28, wherein the substrate is translated in at least one direction during at least a portion of the contacting step.

55. The method of claim 54, wherein the substrate is translated in at least two dimensions during at least a portion of the contacting step.

56-57. (canceled)

58. The method of claim 28, wherein the method further comprises the step of drying the substrate after contacting the substrate with the fluid.

59. The method of claim 28, wherein the substrate is composed of a metal, a ceramic, a glass, a polymer or a combination thereof.

60. The method of claim 59, wherein the substrate is composed of stainless steel, platinum, iridium, palladium, nickel, gold, titanium, zirconium, inconel, cobalt steel, aluminum, copper, zinc, bronze, metal plating, metal foams, magnetic substrates, polypropylene, neoprene, Buna-N, Butyl Rubber, silicones, Viton, EPDM, polyurethane, polyetheretherketone, nylon, Teflon, Tyvek, biocompatible fabrics and polymers, cellulose acetates, PVC, CPVC, polycarbonate, Delrin, polyetherimide, polyamide, polyimide, silicon dioxide, borosilicate, quartz, alumina, silica, borosilicate, zirconium oxide, silicon carbide, boron nitride, magnetic ceramics, superconductive ceramics, or combinations thereof.

61-62. (canceled)

63. The method of claim 28, wherein the substrate is a medical device, a biomedical implant, a semiconductor wafer, an electronic device, or optical element.

64. The method of claim 63, wherein the substrate is a medical device.

65. The method of claim 64, wherein the substrate is a reusable endoscope.

66. A method of cleaning a substrate comprising the steps of
applying a translational force to the substrate; and
contacting a substrate with a fluid comprising percarbonic acid under conditions conducive to removing contaminants from the substrate.

67. (canceled)

68. The method of claim 66, wherein the method comprises the steps of
applying a translational force and ultrasound to the substrate; and
contacting a substrate with a fluid comprising percarbonic acid under conditions conducive to removing contaminants from the substrate.

69. The method of claim 66, wherein the fluid is contacted with the substrate while the translational force is applied thereto.

70. The method of claim 66, wherein the contaminants are biological, organic, inorganic, or particulate residues.

71. A method of at least one of disinfecting or sterilizing a substrate, the method comprising the steps of
applying a translational force to the substrate; and
contacting a substrate with a fluid comprising percarbonic acid under conditions conducive to sterilizing the substrate.

72. (canceled)

73. The method of claim 71, wherein the method comprises the steps of
applying a translational force and ultrasound to the substrate; and
contacting a substrate with a fluid comprising percarbonic acid under conditions conducive to removing contaminants from the substrate.

74. (canceled)

75. A method of cleaning and sterilizing a substrate, the method comprising the steps of
applying a translational force to the substrate; and
contacting a substrate with a fluid comprising percarbonic acid under conditions conducive to removing contaminants from the substrate and conducive to sterilizing the substrate.

76. (canceled)

77. The method of claim 75, wherein the contaminants are biological, organic, inorganic, or particulate residues.

78. The method of claim 75, wherein the translational force is a centripetal or Coriolis force.

79-80. (canceled)

81. The method of claim 75, wherein the fluid and the substrate are contacted with a plasma.

82-83. (canceled)

84. The method of claim 75, wherein the fluid and the substrate are irradiated with UV light during at least a portion of the contacting step.

85. The method of claim 84, wherein at least about 40% of the UV irradiation has a wave length of less than 300 nm.

86. (canceled)

87. The method of claim 75, wherein the fluid further comprises at least one additive.

88. (canceled)

89. An apparatus for cleaning or sterilizing a substrate with percarbonic acid comprising a cleaning chamber, a UV irradiation source, an electrical field generator, a device capable of applying a translational force to the substrate, and a percarbonic acid generator or percarbonic acid source.

90. A method for monitoring in-situ a process for cleaning or sterilization a test substrate, the method comprising the steps of:
providing a test substrate having at least one chemical or biological contaminant deposited thereon;
measuring the UV-Vis spectrum of the test substrate prior to cleaning or sterilizing;
contacting the test substrate with the fluid comprising percarbonic acid under conditions conducive to cleaning or sterilizing the substrate;
measuring the UV-Vis spectrum of the test substrate periodically during and after contacting the test substrate with the fluid; and
comparing the periodic UV-Vis spectra against the pre-cleaning or pre-sterilizing UV-Vis spectrum to monitor the cleaning or sterilization process.

91. The method of claim 71, wherein the fluid is contacted with the substrate while the translational force is applied thereto.

92. The method of claim 71, wherein the translational force is a centripetal or Coriolis force.
